(19) United States
(12) Patent Application Publication
(10) Pub. No.: US 2026/0360889 A1
(43) Pub. Date: Nov. 12, 2026

(54) ENERGY STORAGE POWER SUPPLY AND ENERGY STORAGE POWER SUPPLY SYSTEM

(71) Applicant: SHENZHEN HELLO TECH ENERGY CO., LTD, Shenzhen (CN)

(72) Inventors: Chao HU, Shenzhen (CN); Gaosong SHEN, Shenzhen (CN); Zhongwei SUN, Shenzhen (CN)

(21) Appl. No.: 19/726,896

(22) Filed: Jun. 30, 2026

(30) Foreign Application Priority Data
Dec. 29, 2025 (CN) 202512044607.0

(51) Int. Cl. H01M 50/209; H01M 10/42; H01M 10/613; H01M 10/667; H01M 50/251

(52) U.S. Cl. CPC H01M 50/209; H01M 10/425; H01M 10/613; H01M 10/667; H01M 50/251; H01M 2220/10

(57) ABSTRACT

Provided are an energy storage power supply and an energy storage power supply system. The energy storage power supply includes a casing, a battery module, and an inverter. The casing has a mounting cavity. A mounting wall is formed at an inner wall of the mounting cavity. The battery module is mounted in the mounting cavity and includes a plurality of battery cells arranged side by side in a single layer. The plurality of battery cells are laid flat on the mounting wall. The inverter is mounted in the mounting cavity and includes a substrate and circuit component disposed on the substrate. The substrate is laid flat on the mounting wall.

### CROSS-REFERENCE TO RELATED APPLICATIONS

This application claims priority to Chinese Patent Application No. 202512044607.0, filed on Dec. 29, 2025, and Chinese Patent Application No. 202522816476.9, filed on Dec. 29, 2025, both of which are hereby incorporated by reference in their entireties.

### FIELD

The present disclosure relates to the field of energy storage technologies, and in particular, to an energy storage power supply and an energy storage power supply system.

### BACKGROUND

In the related art, an energy storage power supply includes a battery pack and an inverter. The battery pack typically includes a plurality of battery cells arranged in a matrix. A substrate of the inverter is fixedly disposed on a surface of the battery pack. Consequently, the energy storage power supply is generally in a cuboid shape with dimensions that are substantially the same in length and width, which causes use of the energy storage power supply to be limited in a relatively small space.

### SUMMARY

Embodiments of the present disclosure provide an energy storage power supply and an energy storage power supply system, which can solve at least one of the above technical problems.

An embodiment of the present disclosure provides an energy storage power supply. The energy storage power supply includes: a casing having a mounting cavity, a mounting wall being formed at an inner wall of the mounting cavity; a battery module mounted in the mounting cavity, the battery module including a plurality of battery cells arranged side by side in a single layer, in which the plurality of battery cells are laid flat on the mounting wall; and an inverter mounted in the mounting cavity. The inverter is spaced apart from and electrically connected to the battery module, and the inverter includes a substrate and a circuit component disposed on the substrate. The substrate is laid flat on the mounting wall.

An embodiment of the present disclosure provides another energy storage power supply. The energy storage power supply is in a cuboid shape. A ratio of a length of the energy storage power supply to a thickness of the energy storage power supply is greater than 8; a ratio of a width of the energy storage power supply to the thickness of the energy storage power supply is greater than 4; and a capacity of the energy storage power supply is greater than 0.5 kWh.

An embodiment of the present disclosure provides an energy storage power supply system. The energy storage power supply system includes the energy storage power supply according to any of the above embodiments, a power expansion pack, and a cable. The cable is configured to electrically connect the power expansion pack and the energy storage power supply.

In the energy storage power supply and the energy storage power supply system according to the embodiments of the present disclosure, the battery module is mounted in the mounting cavity and includes the plurality of battery cells arranged side by side in a single layer. The battery cells are laid flat on the mounting wall. The inverter includes the substrate and the circuit component disposed on the substrate. Moreover, the substrate is laid flat on the mounting wall, which can effectively reduce a space occupied by the battery module and the inverter in a direction perpendicular to the mounting wall. In this way, compared with the related art, the arrangement of the battery module and the inverter in the casing in the present disclosure can avoid a dimensional increase caused by three-dimensional stacking, to reduce a dimension of the energy storage power supply in the direction perpendicular to the mounting wall. Consequently, it is beneficial to the realization of thinning of the energy storage power supply, enabling the energy storage power supply to better adapt to a scenario with strict mounting space requirements, preventing use of the energy storage power supply from being limited in a relatively small space, and further enhancing applicability of the energy storage power supply.

Additional aspects and advantages of the present disclosure will be provided in part in the following description, or will become apparent in part from the following description, or can be learned from the practice of the present disclosure.

### BRIEF DESCRIPTION OF THE DRAWINGS

The above and/or additional aspects and advantages of the present disclosure will become apparent and readily appreciated from the following description of the embodiments in conjunction with the accompanying drawings, in which:

FIG. 1(a) is a schematic view showing a perspective structure of an energy storage power supply in the prior art.

FIG. 1(b) is a schematic perspective exploded view of an energy storage power supply in the prior art.

FIG. 1(c) is a schematic view showing a perspective structure of an energy storage power supply according to some embodiments of the present disclosure.

FIG. 2 is a schematic perspective exploded view of one type of energy storage power supply shown in FIG. 1(c).

FIG. 3 is a schematic view showing a perspective structure of a mounting member according to some embodiments of the present disclosure.

FIG. 4 is a schematic perspective exploded view of another type of energy storage power supply shown in FIG. 1(c).

FIG. 5 is a schematic view showing a plane structure of the energy storage power supply shown in FIG. 1(c).

FIG. 6 is a schematic perspective exploded view of a partial structure of the energy storage power supply shown in FIG. 1(c).

FIG. 7 is another schematic perspective exploded view of a partial structure of the energy storage power supply shown in FIG. 1(c).

FIG. 8 is a cross-sectional structural schematic view of the energy storage power supply shown in FIG. 1(c).

FIG. 9 is another schematic perspective exploded view of the energy storage power supply shown in FIG. 1(c).

FIG. 10 is yet another schematic perspective exploded view of the energy storage power supply shown in FIG. 1(c).

FIG. 11 is still yet another schematic perspective exploded view of the energy storage power supply shown in FIG. 1(c).

FIG. 12 is another cross-sectional structural schematic view of the energy storage power supply shown in FIG. 1(c).

FIG. 13 is a schematic view showing a perspective structure of an energy storage power supply according to some embodiments of the present disclosure.

FIG. 14 is a schematic perspective exploded view of the energy storage power supply shown in FIG. 13.

FIG. 15 is a schematic view showing a perspective structure of a hanging member according to some embodiments of the present disclosure.

FIG. 16 is another schematic perspective exploded view of the energy storage power supply shown in FIG. 13.

FIG. 17 is a schematic view showing a perspective structure of an energy storage power supply according to some embodiments of the present disclosure.

FIG. 18 is a schematic perspective exploded view of the energy storage power supply shown in FIG. 17.

FIG. 19 is a cross-sectional structural schematic view of the energy storage power supply shown in FIG. 17.

FIG. 20 is a schematic view showing a perspective structure of an energy storage power supply system according to some embodiments of the present disclosure.

FIG. 21 is a planar structural schematic view of a partial structure of the energy storage power supply system shown in FIG. 20.

FIG. 22 is a schematic view of a plane structure of the energy storage power supply system shown in FIG. 20.

FIG. 23 is another schematic view of a plane structure of the energy storage power supply system shown in FIG. 20.

FIG. 24 is a schematic perspective exploded view of the energy storage power supply system shown in FIG. 20.

FIG. 25 is another schematic perspective exploded view of the energy storage power supply system shown in FIG. 20.

### DETAILED DESCRIPTION

Embodiments of the present disclosure will be further described below with reference to the accompanying drawings. Same or similar elements, or elements having same or similar functions, are denoted by same or similar reference numerals in the accompanying drawings.

In addition, the embodiments of the present disclosure described below with reference to the accompanying drawings are illustrative only, and are intended to explain the embodiments of the present disclosure, rather than limit the present disclosure.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

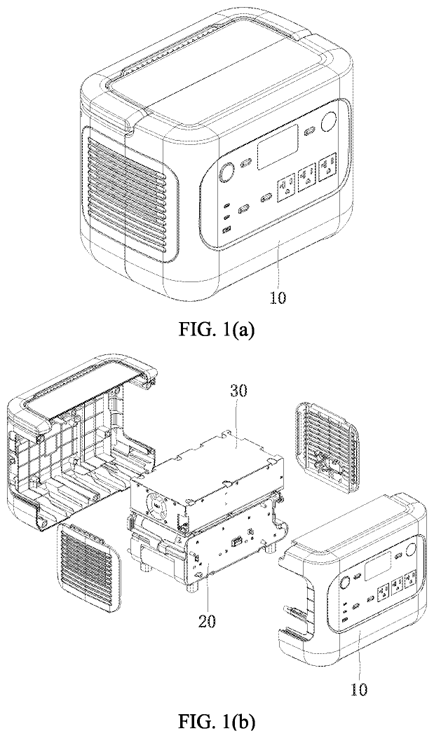

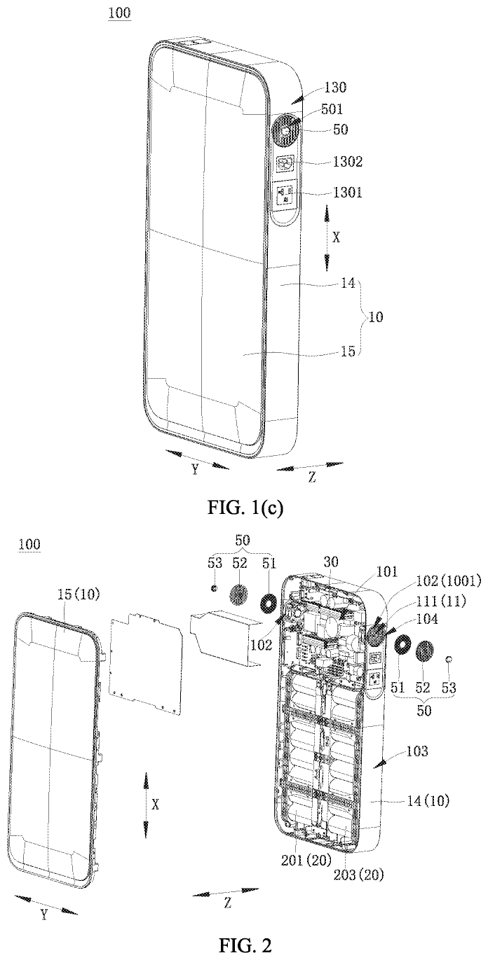

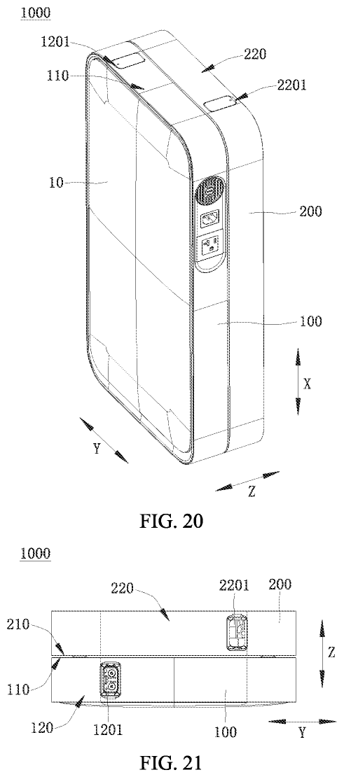

Referring to FIG. 1(a) and FIG. 1(b), FIG. 1(a) is a schematic view showing a perspective structure of an energy storage power supply in the prior art, and FIG. 1(b) is a schematic perspective exploded view of an energy storage power supply in the prior art. In related art, the energy storage power supply includes a battery pack 20 and an inverter 30. The battery pack 20 typically includes a plurality of battery cells arranged in a matrix. A substrate of the inverter 30 is fixedly disposed on a surface of the battery pack 20. Consequently, the energy storage power supply is generally in a cuboid shape with dimensions that are substantially the same in length and width, which causes use of the energy storage power supply to be limited in a relatively small space. In order to solve the above problem, an embodiment of the present disclosure provides an energy storage power supply 100 (as shown in FIG. 1(c)) and an energy storage power supply system 1000 (as shown in FIG. 20).

Referring to FIG. 1(c), FIG. 2, and FIG. 6, an embodiment of the present disclosure provides an energy storage power supply 100. The energy storage power supply 100 includes a casing 10, a battery module 20, and an inverter 30. The casing 10 has a mounting cavity, and a mounting wall 1010 is formed at an inner wall of the mounting cavity. The battery module 20 is mounted in the mounting cavity and includes a plurality of battery cells 21 arranged side by side in a single layer. The plurality of battery cells 21 are laid flat on the mounting wall 1010. The inverter 30 is mounted in the mounting cavity. The inverter 30 is spaced apart from and electrically connected to the battery module 20. The inverter 30 includes a substrate and a circuit component disposed on the substrate. The substrate is laid flat on the mounting wall 1010.

Specifically, in the above embodiment, the energy storage power supply 100 is an electrical device capable of storing electrical energy and releasing it when required, and its main function is to provide stable and reliable power supply. The energy storage power supply 100 may be applied in a power system to achieve functions of demand-side management, electricity shifting from peak periods to off the peak periods, and rapid power grid frequency adjustment, which enhances stability and reliability of power grid operation, and reduces an impact of a renewable energy generation system (such as photovoltaic or wind power with a significant transient variation) on a power grid. Exemplarily, the energy storage power supply 100 may supply power to the electrical device, which includes, but is not limited to, a mobile phone, a laptop, a new-energy vehicle, a ship, and a spacecraft.

The casing 10 is a structure in the energy storage power supply 100 that is capable receiving and protecting structures of components such as the battery module 20 and the inverter 30. A material of the casing 10 includes, but is not limited to, plastic, aluminum alloy, steel, or a carbon fiber composite material. The mounting cavity is a cavity structure formed in the casing 10, and is at least configured to receive the battery module 20 and the inverter 30. The mounting wall 1010 is an inner wall of the mounting cavity for fixing and supporting the battery module 20 and the inverter 30.

The battery module 20 is a module composed of a plurality of energy storage battery cells 21, and is capable of storing and releasing the electrical energy. The battery module 20 may further include other structures. For example, the battery module 20 may further include an electrical connection component configured to realize electrical connections between the plurality of battery cells 21. It can be understood that the number of battery cells 21 in the battery module 20 may be adaptively adjusted based on an application scenario and a capacity of the battery module 20.

The battery cell 21 may be of various types, such as a lithium-ion battery cell, a lead-carbon battery cell, or a liquid flow battery cell. The battery cell 21 may be a cylindrical battery cell, a square battery cell, or a sheet-like battery cell. Through structures, such as a positive electrode plate, a negative electrode plate, an electrolyte, and a separator in the battery cell 21, the electrical energy is converted into chemical energy for storage during charging, and the chemical energy is converted back into electrical energy for release during discharging. In the battery module 20, the plurality of battery cells 21 are provided, and may be connected in series, or in parallel, or in series and parallel. The connection in series and parallel means that a series connection and a parallel connection both occur among the plurality of battery cells 21. The plurality of battery cells 21 may be directly connected in series, or in parallel, or in series and parallel. Then, the resulting assembly formed by the plurality of battery cells 21 is received in the casing 10.

In some embodiments of the present disclosure, the battery cell 21 further includes two electrodes serving as current interfaces of the battery cell 21 for energy supply or charging. The two electrodes are a positive electrode and a negative electrode. The positive electrode may be an element with one end electrically connected to the positive electrode plate and another end electrically connected to an external conductor of the battery cell 21, and be used for outputting or inputting the electrical energy. The negative electrode may be an element with one end electrically connected to the negative electrode plate and another end electrically connected to the external conductor of the battery cell 21, and be used for outputting or inputting the electrical energy. The positive electrode and the positive electrode plate, as well as the negative electrode and the negative electrode plate, may be connected by welding. Stability of the connection between the electrode plates (including the positive electrode plate and the negative electrode plate) and the electrodes (including the positive electrode and the negative electrode) can be improved through welding, which prevents a problem such as disengagement of the electrode plate from being easily caused during long-term use of the battery, and can ensure safety performance of the battery. Each of the positive electrode and the negative electrode need to be made of an electrically conductive metallic material. In some embodiments, the battery cell 21 includes a battery cell body. The two electrodes may be disposed at two opposite ends of the battery cell body in a lengthwise direction of the battery cell body, respectively, or both disposed at a same end of the battery cell body in the lengthwise direction of the battery cell body. Of course, in other embodiments, one of the two electrodes may be disposed at an end of the battery cell body in the lengthwise direction of the battery cell body, and the other one of the two electrodes may be disposed on a side surface of the battery cell body.

The inverter 30 is a circuit component capable of converting a direct current (DC) into an alternating current (AC). The inverter 30 is capable of being electrically connected to the battery module 20 and converting DC power from the battery module 20 into AC power to satisfy requirements of a power grid or load. The provision of the inverter 30 enables the energy storage power supply 100 to be flexibly connected to the power grid or to supply power to the load. Meanwhile, in a particular situation, such as when the power grid has sufficient electricity, the inverter 30 can also convert the AC power into DC power for storage in the energy storage power supply 100, to achieve energy storage and reuse.

The substrate may be a printed circuit board (PCB), which can serve as a mounting seat for the inverter 30, and is used for fixing and being electrically connected to the circuit component. The circuit component is a core electronic element in the inverter 30 that implements electrical energy conversion, which includes, but is not limited to, a power switching device (such as an IGBT or MOSFET), an inductor, a capacitor, a relay, and a diode. The circuit component may be fixed and electrically connected to the substrate by welding, insertion, or surface mounting.

Flat laying means that a plurality of components or structural units may be laid out in a flat, non-overlapping, and regular arrangement manner in a specific space. Its core features include coplanarity, non-overlap, and regularity. That is, all components or structural units lie on a same plane or parallel planes. There is no three-dimensional intersection or projected overlap between the units. Moreover, the units are arranged in an orderly pattern, such as a matrix, honeycomb, or linear layout. In some embodiments of the present disclosure, the battery module 20 includes a plurality of battery cells 21 arranged side by side in a single layer, and the plurality of battery cells 21 are laid flat on the mounting wall 1010. The inverter 30 is spaced apart from and electrically connected to the battery module 20. The inverter 30 includes a substrate and a circuit component disposed on the substrate. The substrate is laid flat on the mounting wall 1010. That is, the plurality of battery cells 21 are arranged on the mounting wall 1010 without stacking. Moreover, a projection of the battery cell 21 on the mounting wall 1010 does not overlap or intersect with a projection of the inverter 30 on the mounting wall 1010. In this way, the arrangement of the battery module 20 and the inverter 30 in the embodiments of the present disclosure can effectively reduce a dimension of the mounting wall 1010 in a direction perpendicular to the mounting wall 1010, which allows the energy storage power supply 100 to have a smaller dimension in the direction perpendicular to the mounting wall 1010. Further, it is helpful for the energy storage power supply 100 to better adapt to a scenario with strict mounting space requirements, preventing the use of the energy storage power supply 100 from being limited in a relatively small space, and further enhancing applicability of the energy storage power supply 100.

Referring to FIG. 1(c), FIG. 2, and FIG. 6, in some embodiments, the casing 10 has an external profile extending in a first direction X, a second direction Y, and a third direction Z. The first direction X, the second direction Y, and the third direction Z are perpendicular to each other. The mounting wall 1010 is perpendicular to the third direction. A lengthwise direction of the plurality of battery cells 21 is arranged in the first direction X or the second direction Y. The inverter 30 and the battery module 20 are spaced apart from one another in the first direction X and electrically connected. The substrate is disposed perpendicularly to the third direction Z. Moreover, the circuit component is disposed to extend in the third direction Z. A projection of the inverter 30 in the first direction X at least partially overlaps with a projection of the battery module 20 in the first direction X.

The external profile of the casing 10 refers to a geometric shape formed by the boundary of an outer surface of the casing 10. For example, the external profile of the casing 10 may be a rectangular parallelepiped, a cylinder, or other polyhedrons. In some embodiments of the present disclosure, the casing 10 has the external profile extending in the first direction X, the second direction Y, and the third direction Z. Moreover, the first direction X, the second direction Y, and the third direction Z are perpendicular to each other. In this way, the external profile of the casing 10 may be substantially in a cuboid shape. Dimensions of the external profile of the casing 10 in the first direction X, the second direction Y, and the third direction Z may be the same or different. The first direction X may be a length direction of the casing 10, the second direction Y may be a width direction of the casing 10, and the third direction Z may be a thickness direction of the casing 10.

The lengthwise direction of the battery cell 21 is arranged in the first direction X or the second direction Y. That is, the lengthwise direction of the battery cell 21 is parallel to the first direction X or the second direction Y. In this way, the battery module 20 can have a smaller dimension in the third direction Z, which reduces a space occupied by the casing 10 in the third direction Z, thereby helping to reduce a dimension of the energy storage power supply 100 in the third direction Z. It should be additionally noted that, in some embodiments, the lengthwise direction of the battery cell 21 refers to an axial direction of a maximum dimension of the battery cell 21. For example, for the cylindrical battery cell, the lengthwise direction of the battery cell 21 is a direction of a central axis of the cylinder. For the square battery cell, the lengthwise direction of the battery cell 21 is a direction of the longest side of the battery cell 21.

For ease of understanding, the following embodiments take an example for description where the lengthwise direction of the battery cell 21 is arranged in the second direction Y. The inverter 30 and the battery module 20 are spaced apart from one another in the first direction X, and the projection of the inverter 30 in the first direction X at least partially overlaps with the projection of the battery module 20 in the first direction X. That is, the plurality of battery cells 21 and the inverter 30 may be laid flat on the casing 10 in the first direction X, and an orthogonal projection of the plurality of battery cells 21 on the casing 10 in the third direction Z and an orthogonal projection of the inverter 30 on the casing 10 in the third direction Z do not overlap with each other. In this way, compared with an arrangement where the plurality of battery cells 21 are stacked in multiple rows and columns and laminated with the inverter 30, the arrangement of the plurality of battery cells 21 and the inverter 30 in the present disclosure can effectively avoid an increased thickness caused by three-dimensional stacking. Consequently, it is beneficial to the realization of thinning of the energy storage power supply 100, enabling the energy storage power supply 100 to better adapt to the scenario with strict mounting space requirements, preventing the use of the energy storage power supply 100 from being limited in a relatively small space, and further enhancing the applicability of the energy storage power supply 100.

The substrate is arranged parallel to the first direction X, and the circuit component disposed to extend in the third direction Z. In this way, the inverter 30 can have a smaller dimension in the third direction Z, which reduces a dimension of a space occupied by the inverter 30 in the third direction Z, and is thus beneficial to the realization of thinning of the energy storage power supply 100 in the third direction Z. It should be noted that, in some embodiments, a dimension of the inverter 30 in the third direction Z may be the smallest among its dimensions in the first direction X, the second direction Y, and the third direction Z.

In some embodiments, the energy storage power supply 100 further includes a Battery Management System (BMS) protection board. During charging and discharging processes, the BMS protection board monitors a state of the battery module 20 and outputs a corresponding control instruction to ensure safe and stable operation of the battery module 20. Exemplarily, a switch is provided on the BMS protection board. In response to detecting an abnormality in the battery module 20, such as over-temperature, over-current, or over-voltage, the switch is turned off to prevent the battery module 20 from charging or discharging. In some embodiments of the present disclosure, the BMS protection board and the inverter 30 may be integrated onto a single circuit board. In this case, the BMS protection board is also arranged perpendicularly to the third direction Z. Of course, in other embodiments, the BMS protection board and the substrate may be two independent circuit boards. It should be additionally noted that, in some embodiments, the inverter 30 being electrically connected to the battery module 20 may be that the inverter 30 is directly electrically connected to the battery module 20, or that the inverter 30 is indirectly electrically connected to the battery module 20 through an intermediate circuit, such as the inverter 30 being electrically connected to the battery module 20 through the BMS protection board.

In some embodiments, the projection of the inverter 30 in the first direction X overlaps with the projection of the battery module 20 in the first direction X. Alternatively, the projection of the inverter 30 in the first direction X at least partially overlaps with the projection of the battery module 20 in the first direction X. For example, a degree of overlap between the projection of the inverter 30 in the first direction X and the projection of the battery module 20 in the first direction X is greater than 80%. In this way, compared with a case where the projection of the inverter 30 in the first direction X does not overlap with the projection of the battery module 20 in the first direction X or where the degree of the overlap between the projection of the inverter 30 in the first direction X and the projection of the battery module 20 in the first direction X is smaller than 80%, spaces occupied by the battery module 20 and the inverter 30 in the third direction Z are smaller, which can ensure a thinning effect of the energy storage power supply 100.

Referring to FIG. 1(c) and FIG. 2, in some embodiments, the casing 10 is in a cuboid shape, and the plurality of battery cells 21 and the inverter 30 are laid flat on a plane defined by the first direction X and the second direction Y.

Specifically, the plurality of battery cells 21 and the inverter 30 are laid flat on the plane defined by the first direction X and the second direction Y. In this way, the plurality of battery cells 21 and the inverter 30 can fully utilize a space in the first direction X and the second direction Y, which avoids an increased thickness of the casing 10 caused by stacking the plurality of battery cells 21 and the inverter 30 in the third direction Z, effectively achieves the thinning of the energy storage power supply 100, and improves the applicability of the energy storage power supply 100.

Referring to FIG. 2 and FIG. 6, in some embodiments, the battery module 20 includes a first battery module 201 and a second battery module 203 that are spaced apart from one another in the second direction Y. The first battery module 201 includes a plurality of first battery cells 211 arranged side by side in the first direction X. A lengthwise direction of each of the plurality of first battery cells 211 is arranged in the second direction Y. The second battery module 203 includes a plurality of second battery cells 213 arranged side by side in the first direction X. A lengthwise direction of each of the plurality of second battery cells 213 is arranged in the second direction Y.

Specifically, in the above embodiments, the first battery module 201 and the second battery module 203 are arranged in the second direction Y. In this way, compared with a case where the first battery module 201 and the second battery module 203 are arranged in the first direction X, a dimension of the casing 10 in the first direction X can be effectively prevented from becoming excessively large, allowing the casing 10 to form a relatively regular cube while enabling the energy storage power supply 100 to have a higher energy storage capacity. In addition, the first battery module 201 and the second battery module 203 are arranged in the second direction Y. In this way, when the energy storage power supply 100 is arranged vertically, i.e., when the energy storage power supply 100 is arranged vertically in the first direction X, it is possible to reduce a center of gravity of the energy storage power supply 100 and make the center of gravity of the energy storage power supply 100 more centered by the first battery module 201 and the second battery module 203, which can reduce a risk of the energy storage power supply 100 tipping over.

Moreover, since a dimension of the inverter 30 in the second direction Y is relatively large, whereas a dimension of a single battery module 20 in the second direction Y is much smaller than that of the inverter 30 in the second direction Y, in the embodiment of the present disclosure, a total dimension of the first battery module 201 and the second battery module 203 in the second direction Y is made match the dimension of the inverter 30 in the second direction Y by arranging the first battery module 201 and the second battery module 203 in the second direction Y, effectively improving a space utilization rate.

In some embodiments, a projection of the first battery module 201 in the first direction X and a projection of the second battery module 203 in the first direction X overlap with the projection of the inverter 30 in the first direction X. Alternatively, a degree of overlap between the projection of the first battery module 201 in the first direction X and the projection of the second battery module 203 in the first direction X and the projection of the inverter 30 in the first direction X is greater than 80%. In this way, the first battery module 201 and the second battery module 203 are allowed to fully utilize a space of the inverter 30 in the second direction Y, enabling the energy storage power supply 100 to achieve a higher energy storage capacity without increasing a dimension of the casing 10 in the second direction Y.

In some embodiments, the inverter 30 is disposed at a side of the battery module 20 in the first direction X. That is, the plurality of battery cells 21 and the inverter 30 are laid flat on the casing 10 in the first direction X, which fully utilizes a space of the casing 10 in the first direction X, avoids an increase in a width or thickness of the casing 10, and effectively achieves the thinning of the energy storage power supply 100. Moreover, the flat laying arrangement of the battery module 20 and the inverter 30 in the first direction X can prevent mutual thermal interference between the battery module 20 and the inverter 30, improving operational stability and reliability of the energy storage power supply 100.

In some embodiments, a ratio of a length of the casing 10 to a thickness of the casing 10 is greater than 8, and a ratio of a width of the casing 10 to the thickness of the casing 10 is greater than 4. That is, a ratio of the dimension of the casing 10 in the first direction X to a dimension of the casing 10 in the third direction Z is greater than 8, and a ratio of the dimension of the casing 10 in the second direction Y to the dimension of the casing 10 in the third direction Z is greater than 4. In this way, the casing 10 can be generally in the shape of a flat rectangular shape, preventing the use of the energy storage power supply 100 from being limited in a relatively small space. Moreover, when the energy storage power supply 100 is in a wall-mounted state, the energy storage power supply 100 does not protrude excessively from a wall-mounting surface (such as a wall), which can improve wall-mounting stability. In addition, when the energy storage power supply 100 is mounted at a back surface of an electrical device (such as a refrigerator), it can be well concealed behind the electrical device, preventing the electrical device from being positioned too far away from the wall.

In some embodiments, the thickness of the casing 10 is smaller than 10 cm. That is, the dimension of the casing 10 in the third direction Z is smaller than 10 cm. It should be noted that, in some embodiments, the thickness of the casing 10 may be any value smaller than or equal to 10 cm, such as 10 cm, 9 cm, 8 cm, 7.0 cm, 6.5 cm, 6.0 cm, 5.5 cm, 5.0 cm, 4.5 cm, 4.0 cm, 3.5 cm, or 3.0 cm, or any numerical value between any two of these values. Exemplarily, when the thickness of the casing 10 is 6 cm, the width of the casing 10 may be greater than or equal to 24 cm, and the length of the casing 10 may be greater than or equal to 48 cm.

Referring to FIG. 2, in some embodiments, a heat dissipation channel 101 is formed in the casing 10. The inverter 30 is at least partially thermally coupled to the heat dissipation channel 101, and a flow direction of the heat dissipation channel 101 is parallel to the second direction Y.

The heat dissipation channel 101 is a path configured to guide the flow of a cooling medium (such as air, liquid, or a phase-change material), and is capable of transferring heat from a heating element to an external environment to maintain the device operating in a safe temperature range. Thermal coupling refers to a physical connection state between two or more objects or systems through which heat transfer is achieved through conduction, convection, or radiation.

In some embodiments of the present disclosure, the heat dissipation channel 101 is capable of allowing air to flow therethrough. Heat generated by the heating element on the inverter 30 (such as an IGBT, MOSFET, or a capacitor) can be transferred to the heat dissipation channel 101, enabling the air to carry the heat away when flowing in the heat dissipation channel 101 and thus achieving heat dissipation for the inverter 30. Moreover, the flow direction of the heat dissipation channel 101 is parallel to the second direction Y, i.e., the air in the heat dissipation channel 101 flows in a straight line in a direction parallel to the second direction Y. In this way, on the one hand, the heat dissipation channel 101 can be prevented from occupying excessive space of the casing 10 in the third direction Z, which is helpful to realize the thinning of the energy storage power supply 100. On the other hand, an airflow flow path can be shortened, which enables the heat to be conducted out more quickly, and thus improve heat dissipation efficiency.

In addition, referring to the above, the inverter 30 and the battery module 20 are spaced apart from one another in the first direction X, and the heat dissipation channel 101 is arranged in the direction parallel to the second direction Y. In this way, a hot airflow after the inverter 30 is cooled in the heat dissipation channel 101 can be prevented from flowing to the battery module 20 and causing overheating damage to the battery module 20, which can improve the operational stability and reliability of the energy storage power supply 100.

In some embodiments, the energy storage power supply 100 further includes an air guide cover disposed in the casing 10 and covering at least a part of the inverter 30. The air guide cover and the casing 10 together form the heat dissipation channel 101.

The air guide cover is a mechanical structure configured to guide a flow direction of the airflow. The air guide cover is mounted in the casing and cooperates with the casing or other components to form a directional heat dissipation channel. The provision of the air guide cover can optimize an airflow path, improve the heat dissipation efficiency, ensure rapid and uniform discharging of heat from the heating element (such as the heating element on the inverter 30), and avoid local overheating. It should be noted that, in some embodiments of the present disclosure, an extending direction of the air guide cover is parallel to the second direction Y.

Referring to FIG. 2 to FIG. 4, in some embodiments, the casing 10 has a ventilation region 1001. The ventilation region 1001 has a plurality of heat dissipation holes 102. An inner cavity of the casing 10 is in communication with an outside through the plurality of heat dissipation holes 102. The energy storage power supply 100 further includes a protection component 50. The protection component 50 includes a protection mesh 51 detachably connected to the casing 10 and covering the ventilation region 1001. A flow cross-sectional area of mesh openings of the protection mesh 51 is smaller than a flow cross-sectional area of the plurality of heat dissipation holes 102.

The ventilation region 1001 is a region on the casing 10 for achieving airflow exchange between the inner cavity of the casing 10 and the external environment, which can promote heat dissipation in the inner cavity of the casing 10 and prevent accelerated aging or even overheating damage of internal electrical components caused by an excessively high internal temperature of the casing 10. The heat dissipation hole 102 is an opening structure located in the ventilation region 1001, and is at least configured to discharge heat from an interior of the casing 10 to the outside. In the present disclosure, the inner cavity of the casing 10 can be connected to the outside by heat dissipation hole 102, enabling heat from the inner cavity of the casing 10 to be discharged to the outside, rather than relying solely on natural heat dissipation through thermal conduction of a side wall of the casing 10, which is beneficial to an improvement in a heat dissipation effect. A shape of the ventilation region 1001 includes, but is not limited to, a circle, a square, and a triangle. In the present disclosure, as an example, the ventilation region 1001 is taken being in a circular shape for illustration.

The protection mesh 51 is of a mesh structure covering the heat dissipation hole 102, and can prevent foreign objects (such as dust, insects, etc.) from entering the casing 10 while allowing the air to flow. A material of the protection mesh 51 includes, but is not limited to, aluminum alloy, stainless steel, plastic and a composite material, or the like. A shape of the protection mesh 51 may match the shape of the ventilation region 1001. For example, when the ventilation region 1001 is in a circular shape, the protection mesh 51 may also be in a circular shape. In some embodiments of the present disclosure, the protection mesh 51 is detachably connected to the casing 10. In this way, when the mesh openings are blocked by the foreign objects such as dust, oil stains, or insects after long-term use of the protection mesh 51, the protection mesh 51 can be detached from the casing 10 for cleaning. Thus, on the one hand, resistance of the protection mesh 51 to a heat dissipation airflow can be reduced, which is beneficial to the improvement of the heat dissipation effect. On the other hand, reuse of the protection mesh 51 can be realized without the need to replace the protection mesh 51, which is beneficial to a reduction in use costs.

The flow cross-sectional area refers to an effective cross-sectional area actually available for free flow when a fluid (such as air or liquid) passes through a certain channel or hole. In the present disclosure, the flow cross-sectional area of the mesh openings of the protection mesh 51 is smaller than the flow cross-sectional area of the heat dissipation hole 102. In this way, compared with a case where the protection mesh 51 is not provided, i.e., compared with an open heat dissipation hole 102, the provision of the protection mesh 51 can reduce a possibility of the foreign objects such as dust and insects entering the casing 10, reduce safety hazards, and improve the operational stability of the energy storage power supply 100.

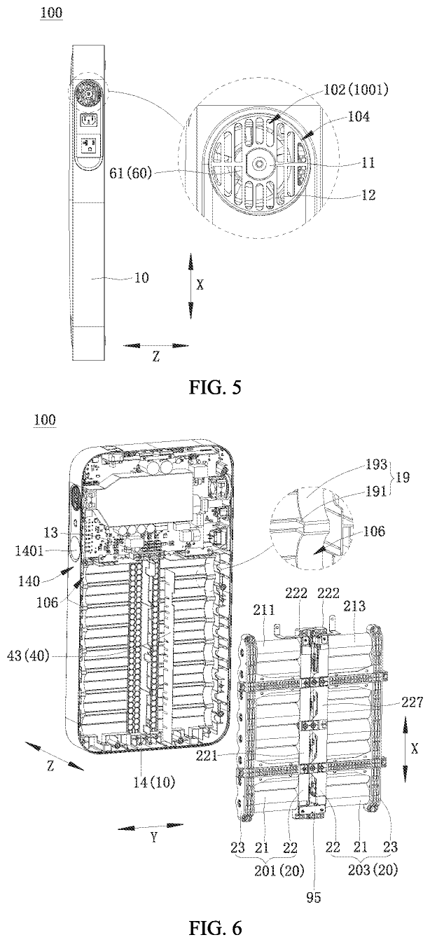

Referring to FIG. 2 and FIG. 5, in some embodiments, a mounting groove 104 corresponding to the ventilation region 1001 is formed on an outer side surface 103 of the casing 10, and the protection component 50 is at least partially received in the mounting groove 104. In this way, the formation of the mounting groove 104 can facilitate mounting and positioning of the protection component 50 on the casing 10, improving assembly efficiency.

The mounting groove 104 may be formed by recessing from the outer side surface 103 of the casing 10 towards the inner cavity of the casing 10, and the heat dissipation hole 102 penetrates a bottom wall of the mounting groove 104 and is in communication with the mounting groove 104. A dimension of the mounting groove 104 is greater than a dimension of the ventilation region 1001. In this way, when the protection component 50 is received in the mounting groove 104, the protection component 50 can effectively cover the ventilation region 1001 to prevent the foreign objects from entering inside of the casing 10. Exemplarily, a cross-sectional shape of the mounting groove 104 may be circular, the ventilation region 1001 is circular, and a cross-sectional shape of the protection mesh 51 is also circular. Moreover, a cross-sectional dimension of the mounting groove 104 is greater than a diameter of the ventilation region 1001, and a cross-sectional dimension of the protection mesh 51 is substantially the same as the cross-sectional dimension of the mounting groove 104. In this way, when the protection mesh 51 is received in the mounting groove 104, the ventilation region 1001 can be completely covered, effectively preventing the foreign objects from entering the inside of the casing 10.

Referring to FIG. 1(c), in some embodiments, an outer side surface 501 of the protection component 50 is flush with the outer side surface 103 of the casing 10. In this way, an outer surface of the energy storage power supply 100 integrally forms a smooth and continuous visual effect, reducing visual defects and improving aesthetics.

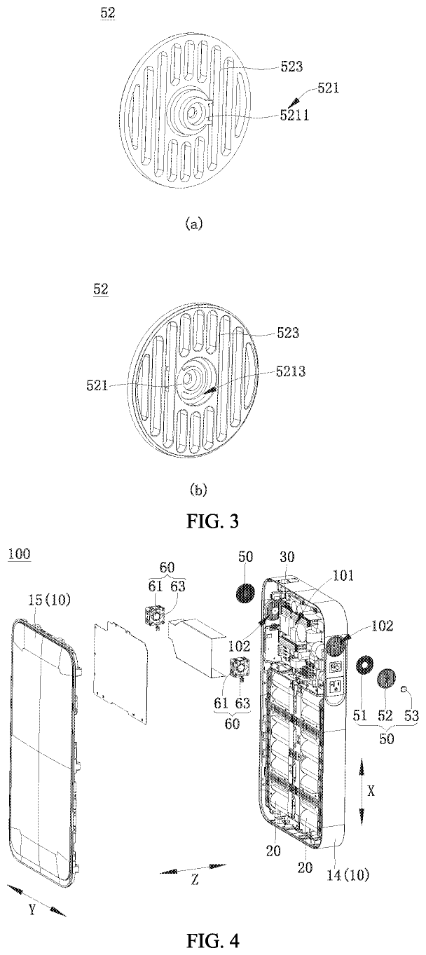

Referring to FIG. 2, FIG. 3, and FIG. 5, in some embodiments, the ventilation region 1001 includes a first mounting region 11 and a first grille 12. The first grille 12 is connected to a periphery of the first mounting region 11, and the plurality of heat dissipation holes 102 is formed on the first grille 12. The mounting member 52 includes a second grille 523 and a second mounting region 521. The second grille 523 is connected to a periphery of the second mounting region 521 and directly faces towards the first grille 12. The protection component 50 further includes a fastener. The mounting member 52 and the protection mesh 51 are fixed to the casing 10 by fastener sequentially passing through the second mounting region and the protection mesh and being connected to the first mounting region 11.

The grille is a rigid open structure composed of repeatedly arranged strip, sheet, or mesh units. It is primarily used to control a flow direction or flow rate of a fluid (such as air or liquid) or to filter the foreign objects, while also serving protective and decorative functions. In some embodiments of the present disclosure, the first grille 12 may be in the form of parallel strips, and is connected to the periphery of the first mounting region 11. It should be noted that, in some embodiments, the first mounting region 11 may be of a solid structure.

Specifically, the fastener can be locked to the first mounting region 11 after passing through the mounting member 52 and the protection mesh 51, thereby achieving mounting and fixation of the mounting member 52 and the protection mesh 51 on the casing 10. That is, the fastener can achieve the mounting and fixation of the mounting member 52 and the protection mesh 51 through a single locking operation, which reduces assembly steps and improves the assembly efficiency. Moreover, the fastener penetrates the protection mesh 51. Thus, through cooperation between the fastener and the protection mesh 51, displacement of the protection mesh 51 can be prevented, ensuring effective covering of the heat dissipation hole 102 by the protection mesh 51.

It should be noted that, in some embodiments, the fastener may be a threaded fastener (such as a bolt or a screw), a rivet, a pin, or the like. In the present disclosure, as an example, the fastener is taken as the threaded fastener for illustration. In this way, the mounting member 52 and the protection mesh 51 can be detachably fixed by the fastener to the casing 10, which can facilitate disassembly, assembly, and maintenance of the protection mesh 51 and the mounting member 52, facilitating reuse.

Referring to FIG. 3, the second grille 523 directly faces the first grille 12. That is, s shaped or mesh-shaped openings of the first grille 12 and the second grille 523 completely overlap with each other, such that a continuous air flow channel is formed between the first grille 12 and the second grille 523, which prevents the second grille 523 from blocking an airflow entering or exiting the inner cavity of the casing 10 through the first grille 12, thus improving the heat dissipation effect.

In some embodiments, the mounting member 52 is substantially in the shape of a circular disc, and the second mounting region 521 is formed at a center of the mounting member 52.

The mounting member 52 has a centrally symmetric structure, and the second mounting region 521 is formed at the center of the mounting member 52. In this way, when the fastener passes through the second mounting region 521 and is connected to the first mounting region 11, a clamping force exerted by the fastener on the mounting member 52 is evenly transmitted from the center to the periphery, which allows for uniform stress distribution across the mounting member 52, and reduces the possibility of deformation of the mounting member 52. Moreover, only a single fastener is required to realize the mounting and fixation of the mounting member 52 on the casing 10, which reduces the number of components needed for mounting and facilitates disassembly and assembly of the mounting member 52.

Referring to FIG. 2 and FIG. 3, in some embodiments, a positioning groove 111 is formed on the first mounting region 11, and a positioning protrusion 5211 is formed on an inner side surface of the second mounting region 521. The positioning protrusion 5211 can extend into the positioning groove 111. Engagement between the positioning protrusion 5211 and the positioning groove 111 can facilitate mounting and positioning of the mounting member 52 on the casing 10, improving the assembly efficiency.

In some embodiments, the positioning groove 111 is a D-shaped groove, and an external profile of the positioning protrusion 5211 matches the positioning groove 111. In this way, on the one hand, the mounting member 52 can be prevented from rotating relative to the casing 10 during a fastener connection process, eliminating the need to apply a holding force to limit the mounting member 52, which makes the mounting operation more convenient. On the other hand, relative positions of the mounting member 52 and the casing 10 can be prevented from shifting during the connection process, ensuring that strips of the first grille 12 directly face strips of the second grille 523.

In some embodiments, a decorative groove 5213 is formed on an outer side surface of the second mounting region 521. The protection component 50 further includes a decorative member 53 detachably connected in the decorative groove 5213 and covering the first fastener.

The provision of the decorative member 53 can prevent the first fastener from being exposed, so as not to affect the overall appearance, thereby improving the aesthetics. Meanwhile, a protection effect can also be achieved on the first fastener, reducing the possibility of corrosion and rusting of the first fastener. It should be noted that, in some embodiments, the outer side surface 501 of the protection component 50 may be jointly formed by a side of the mounting member 52 facing away from the protection mesh 51 and a side of the decorative member 53 facing away from the protection mesh 51.

Referring to FIG. 2, FIG. 4, FIG. 5, and FIG. 6, in some embodiments, the casing ha ventilation region 1001. The ventilation region 1001 includes a first grille 12 and a first mounting region 11. The first grille 12 is connected to a periphery of the first mounting region 11 and has a plurality of heat dissipation holes 102, and the first mounting region 11 is configured to enhance a structural strength of the first grille 12. The energy storage power supply 100 further includes a cooling fan 60 disposed in the casing 10 and close to the plurality of heat dissipation holes 102. The cooling fan 60 is configured to generate an airflow passing through the plurality of heat dissipation holes 102. The cooling fan 60 includes a driving member 61 and a blade 63 coupled to the driving member 61. An orthographic projection of the driving member 61 on the ventilation region 1001 at least partially overlaps with the first mounting region 11, and an orthographic projection of the blade 63 on the ventilation region 1001 at least partially overlaps with the first grille 12.

The first mounting region 11 is configured to enhance the structural strength of the first grille 12, which can reduce the possibility of deformation and damage to the first grille 12, ensuring stable discharging of the heat from the interior of the casing 10. Moreover, the orthographic projection of the driving member 61 on the ventilation region 1001 at least partially overlaps with the first mounting region 11, and the orthographic projection of the blades 63 on the ventilation region 1001 at least partially overlaps with the first grille 12. In other words, the driving member 61 and the first mounting region 11 are substantially arranged directly facing each other, and the blade 63 and the first grille 12 are substantially arranged directly facing each other. This design can optimize cooperation between the ventilation region 1001 and the cooling fan 60, enabling the airflow generated by the cooling fan 60 to smoothly pass through the heat dissipation hole 102 and be discharged to the outside. In this way, obstruction of an internal structure of the ventilation region 1001 (including the first mounting region 11) to the airflow path is reduced, ensuring that the heat in the casing 10 can be efficiently discharged through the heat dissipation holes 102, which is beneficial to the improvement of the heat dissipation effect.

In some embodiments, the cooling fan 60 is an axial fan, the ventilation region 1001 is circular, and the first grille 12 is integrally in the shape of an annular ring.

The annular-ring-shaped first grille 12 is better suited to a generally helical airflow path generated by the axial fan, which allows the airflow to pass through the ventilation region 1001 more smoothly, ensuring that the heat in the casing 10 can be smoothly dissipated to the outside, effectively satisfying heat dissipation requirements of the energy storage power supply 100.

In some embodiments, the first mounting region 11 is disposed in a central region of the ventilation region 1001. In this way, the first grille 12 can form a symmetrical annular ring structure, which prevents turbulence or a vortex from being formed as the airflow passes through the first grille 12, further reducing blocking caused by the first grille 12 to the airflow, increasing an airflow flow rate, and achieving effective heat dissipation.

In some embodiments, the ventilation region 1001 is formed on each of two opposite sides of the casing 10, and the two ventilation regions 1001 are arranged to face each other. Two cooling fans 60 are included, and each disposed close to a corresponding ventilation region 1001. Moreover, directions of airflows generated by the two cooling fans 60 are the same. In this way, the two ventilation regions 1001 directly face each other, which can create a convection effect. Moreover, cooperation between the two cooling fans 60 can accelerate air circulation between the inner cavity of the casing 10 and the outside, further improving the heat dissipation efficiency.

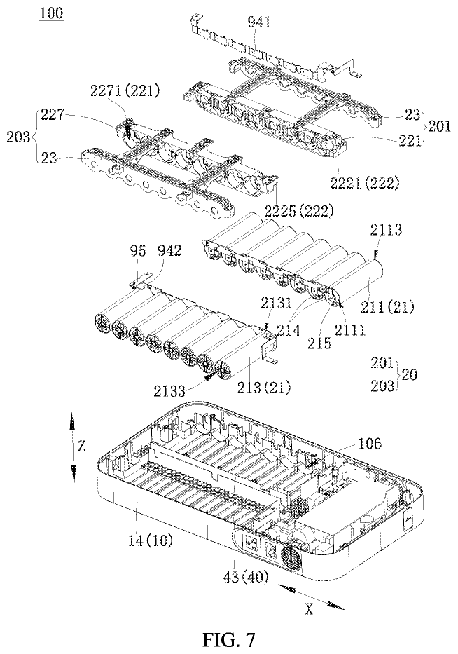

Referring to FIG. 6 and FIG. 7, in some embodiments, the battery module 20 includes a first battery module 201 and a second battery module 203 that are spaced apart from one another in the second direction Y. The first battery module 201 includes a plurality of first battery cells 211 arranged side by side in the first direction X. A lengthwise direction of each of the plurality of first battery cells 211 is arranged in the second direction Y. The second battery module 203 includes a plurality of second battery cells 213 arranged side by side in the first direction X. A lengthwise direction of each of the plurality of second battery cells 213 is arranged in the second direction Y. The first battery cell 211 has a first end 2111 and a second end 2113 in the lengthwise direction of the first battery cell 211, and the second battery cell 213 has a third end 2131 and a fourth end 2133 in the lengthwise direction of the second battery cell 213. The first end 2111 and the third end 2131 are arranged to face each other.

The first battery module 201 is a module composed of a plurality of energy-storing first battery cells 211 and capable of storing and releasing the electrical energy. The first battery module 201 may further include other structures. For example, the first battery module 201 may also include an electrical connection component used for achieving electrical connections among the plurality of first battery cells 211. The number of first battery cells 211 in the first battery module 201 can be adaptively adjusted based on an application scenario and a capacity of the first battery module 201.

The second battery module 203 is a module composed of a plurality of energy-storing second battery cells 213 and capable of storing and releasing the electrical energy. The second battery module 203 may further include other structures. For example, the second battery module 203 may also include an electrical connection component used for achieving electrical connections among the plurality of second battery cells 213. The number of second battery cells 213 in the second battery module 203 can be adaptively adjusted based on an application scenario and a capacity of the second battery module 203. It should be additionally noted that the terms “first battery module 201” and “second battery module 203” in the embodiments of the present disclosure are merely used to distinguish between different battery modules, and do not limit whether the structures of the first battery module 201 and the second battery module 203 are the same or different. Similarly, the terms “first battery cell 211” and “second battery cell 213” in the embodiments of the present disclosure are merely used to distinguish between the battery cells of the first battery module 201 and the battery cells of the second battery module 203, and do not limit whether the structures of the first battery cell 211 and the second battery cell 213 are the same or different.

The lengthwise direction of the first battery cell 211 and the lengthwise direction of the second battery cell 213 are both parallel to the second direction Y. In this way, each of the first battery module 201 and the second battery module 203 can have a smaller dimension in the third direction Z, which is helpful to reduce the dimension of the energy storage power supply 100 in the third direction Z.

Referring to FIG. 7, in some embodiments, each of the first end 2111 and the third end 2131 has a positive electrode and a negative electrode. The first battery module 201 further includes a plurality of first busbars 941. The positive electrode of the first battery cell 211 is connected to the negative electrode of an adjacent first battery cell 211 through a corresponding first busbar 941 of the plurality of first busbars 941 at the first end 2111. The second battery module 203 further includes a plurality of second busbars 942. The positive electrode of the second battery cell 213 is connected to the negative electrode of an adjacent second battery cell 213 through a corresponding second busbar 942 of the plurality of second busbars 942 at the third end 2131. The energy storage power supply 100 further includes a third busbar 95. The first battery module 201 and the second battery module 203 are electrically connected to each other by connecting the plurality of first busbars 941 to the plurality of second busbars 942 through the third busbar 95. An isolation component 40 is further configured to electrically isolate the first busbar 941 from the second busbar 942.

A busbar is a structure with high conductivity, high stability, and high reliability, and is used for concentrating or distributing electrical current. In the field of electrical engineering, the busbar is also referred to as a bus, a bus bar, or the like, and is used to connect a plurality of electrical circuits. The busbar is made of a highly conductive material (such as copper, aluminum, nickel, or an alloy material) to ensure high efficiency of current transmission. The busbar also possesses excellent current-carrying and transferring capabilities, and can respond quickly to a power grid change, ensuring stable operation of the power grid.

Specifically, in some embodiments, the positive electrode of the first battery cell 211 is connected to the negative electrode of an adjacent first battery cell 211 through the corresponding first busbar 941 at the first end 2111. The positive electrode of the second battery cell 213 is connected to the negative electrode of an adjacent second battery cell 213 through the corresponding second busbar 942 at the third end 2131. In this way, the first busbar 941 electrically connected to the plurality of first battery cells 211, and the second busbar 942 electrically connected to the plurality of second battery cells 213 are both concentrated in a region between the first battery module 201 and the second battery module 203. Moreover, since the first end 2111 and the third end 2131 are arranged to face each other, the third busbar 95 electrically connecting the first busbar 941 and the second busbar 942 does not require cross-module wiring, which effectively shortens a dimension of the third busbar 95. In this way, not only can a space required for wiring in the battery module 20 be reduced, helping to miniaturization of the energy storage power supply 100, but the possibility of interference between the busbars and other components can also be reduced, lowering assembly difficulty and safety hazards.

In some embodiments, the energy storage power supply 100 further includes an isolation component 40 disposed between the first end 2111 and the third end 2131.

The isolation component 40 is a structure capable of performing electrical isolation and/or thermal isolation between the first battery cell 211 and the second battery cell 213. The electrical isolation refers to complete separation of a part of a circuit, device, or system from another part of the circuit, device, or system through physical or technical means, ensuring that there is no direct electrical connection (such as a conductive path) between the two parts, thereby blocking direct transfer of current, voltage, or electrical signals.

Exemplarily, the first battery cell 211 is electrically isolated from the second battery cell 213 by the isolation component 40. Specifically, as mentioned above, the first end 2111 and the third end 2131 are arranged to face each other. Therefore, the electrodes on the first end 2111 and the third end 2131 may come into contact, causing a short circuit and compromising safety of the energy storage power supply 100. In the embodiments of the present disclosure, the isolation component 40 is located between the first end 2111 and the third end 2131, and is configured to electrically isolate the first battery cells 211 from the second battery cells 213. In this way, the provision of the isolation component 40 can prevent the short circuit from occurring in the energy storage power supply 100 and ensure use safety of the energy storage power supply 100.

In some embodiments, each of the first end 2111 and the third end 2131 is provided with a pressure relief valve 215. The isolation component 40 is a heat insulation component.

The pressure relief valve 215 is a device configured to automatically release air inside the battery cell to reduce internal pressure when the internal pressure of the battery cell rises abnormally. When a large amount of air is generated inside the battery cell due to thermal runaway, overcharging, over-discharging, an internal short circuit, or other reasons, causing the internal pressure of the battery cell to rise abnormally, the pressure relief valve 215 can rapidly release the pressure to prevent dangerous situations such as rupture or explosion of the battery cell caused by overpressure. The pressure relief valve 215 may be provided with a unidirectional opening weak point. When the internal pressure of the battery cell exceeds a predetermined threshold, the pressure relief valve 215 can automatically open through this weak point to release the air and internal pressure. Subsequently, the pressure relief valve 215 may be able to close as much as possible to isolate the external environment.

The isolation component 40 is a heat insulation component. That is, the isolation component 40 can reduce or block heat transfer between the first battery cell 211 and the second battery cell 213. Specifically, as mentioned above, the first end 2111 and the third end 2131 are arranged to face each other. Therefore, when the pressure relief valve 215 on the first end 2111 or the third end 2131 is damaged, ejecta may be sprayed onto the opposite battery cell, which easily causes propagation of thermal runaway and compromises the safety of the energy storage power supply 100. In the embodiments of the present disclosure, the isolation component 40 is located between the first end 2111 and the third end 2131, and is configured to thermally isolate the first battery cell 211 from the second battery cell 213. In this way, the provision of the isolation component 40 can reduce a risk of thermal runaway propagation in the energy storage power supply 100. That is, the isolation component 40 can effectively prevent the ejecta from being sprayed onto the opposite battery cell after the pressure relief valve 215 of the battery cell is opened, which avoids thermal runaway damage to the opposite battery cell and ensures the use safety of the energy storage power supply 100.

Further, in some embodiments, the isolation component 40 includes a heat insulation plate 43 configured to thermally isolate the first battery cell 211 from the second battery cell 213. It should be noted that, in some embodiments, a material of the heat insulation plate 43 includes, but is not limited to, a mica sheet, aerogel, a ceramic fiber board, or the like. It can be understood that the heat insulation plate 43 may also be made of an insulating material. In this way, the heat insulation plate 43 can also achieve electrical isolation between the first battery cell 211 and the second battery cell 213 to some extent.

In some embodiments, an orthographic projection of the pressure relief valve 215 on the heat insulation plate 43 is completely located on the heat insulation plate 43. In this way, it can be ensured that the pressure relief valves 215 on the first end 2111 and the third end 2131 are completely thermally isolated by the heat insulation plate 43, which effectively reduces a risk of thermal runaway of the energy storage power supply 100 and ensures the use safety of the energy storage power supply 100.

In some embodiments, the casing 10 has a first mounting cavity and a second mounting cavity that are isolated from each other. The battery module 20 is mounted in the first mounting cavity, and the inverter 30 is mounted in the second mounting cavity.

Each of the first mounting cavity and the second mounting cavity is of a cavity structure formed in the casing 10. Both the first mounting cavity and the second mounting cavity can be physically isolated by an internal baffle of the casing 10. In some embodiments of the present disclosure, the first mounting cavity is used to receive the first battery module 201 and the second battery module 203, and the second mounting cavity is used to receive the inverter 30. In this way, an independent layout of functional modules is achieved, preventing heat generated by the operation of the battery module 20 (the first battery module 201 and the second battery module 203) and the inverter 30 from affecting each other, and avoiding damage to internal components caused by an excessively high internal temperature of the casing 10, which can further ensure the operational stability and reliability of the energy storage power supply 100.

Referring to FIG. 1(c), in some embodiments, the casing 10 includes a first mounting surface 130 parallel to the third direction Z. The first mounting surface 130 is provided with at least one of an AC output socket 1301 and an AC input port 1302. It should be noted that, in some embodiments, the first mounting surface 130 may be perpendicular to the first direction X or the second direction Y.

The AC output socket 1301 is an output port on the energy storage power supply 100 used to provide electrical energy to the power grid or the load. When the AC output socket 1301 is electrically connected to the power grid or the load through an electrical connection member, the electrical energy of the energy storage power supply 100 can be transmitted to the power grid or the load through the electrical connection member. The AC input port 1302 is an access port on the energy storage power supply 100 used to receive the electrical energy. When the AC input port 1302 is electrically connected to an external AC power source, such as a power grid or an electric generator, through the electrical connection member, electrical energy of the external AC power source can be transmitted to the energy storage power supply 100 through the electrical connection member. It should be noted that, referring to FIG. 6, in some embodiments, the casing 10 further includes a third mounting surface 140 parallel to the third direction Z, and the third mounting surface 140 is provided with a display screen 1401. It should be noted that, in some embodiments, the third mounting surface 140 faces away from the first mounting surface 130.

Referring to FIG. 6 and FIG. 7, in some embodiments, the casing 10 has a plurality of contoured grooves 106, and the battery module 20 further includes a fixing member 22 and a limiting member 23. The fixing member 22 has a plurality of fixing slots 221. An end of each of the plurality of battery cells 21 in a lengthwise direction of the battery cell 21 is fixed in a corresponding fixing slot 221 of the plurality of fixing slots 221. The battery cell 21 has a side surface engaged with a corresponding contoured groove 106 of the plurality of contoured grooves 106 to be laid flat on the casing 10, and the fixing member 22 is detachably connected to the casing 10. The limiting member 23 is connected to the casing 10. The limiting member 23 includes a limiting portion 231. The limiting portion 231 has a plurality of limiting slots 2311. The side surface of the battery cell 21 is further engaged with a corresponding limiting slot 2311 of the plurality of limiting slots 2311, and the limiting portion 231 is connected to the casing 10 to enable the other end of the battery cell 21 in the lengthwise direction of the battery cell 21 to be pressed between the plurality of limiting slots 2311 and the plurality of contoured grooves 106.

In this way, an end of the battery cell 21 is fixed in the fixing slot 221, the fixing member 22 is detachably connected to the casing 10, and the limiting portion 231 is connected to the casing 10 to enable the other end of the battery cell 21 in the lengthwise direction of the battery cell 21 to be pressed between the limiting slots 2311 and the contoured grooves 106. In this way, the fixing member 22 and the limiting member 23 can jointly fix the two opposite ends of the battery cell 21 in the lengthwise direction of the battery cell 21 to the casing 10, which thus can prevent the battery cell 21 from moving or shaking when subjected to vibration or impact, and improve mounting stability of the battery module 20. Moreover, the limiting member 23 and the contoured groove 106 jointly achieve lateral fixation of the battery cell 21, which thus can ensure mounting stability of the battery cell 21 in the casing 10, effectively avoid the occurrence of rotation, shaking, or even dropping of the battery cell 21, and improve the operational stability and reliability of the energy storage power supply 100. In addition, compared with realizing fixation of the side surface of the battery cell 21 only by the limiting member 23, in the present disclosure, the fixation of the side surface of the battery cell 21 is realized together by the limiting member 23 and the contoured groove 106 on the casing 10, which can reduce a dimension of the limiting member 23 and thus make the limiting member 23 lighter in weight, and is beneficial to the realization of a miniaturization and lightweight design of the battery module 20.

The contoured groove 106 is a groove or cavity manufactured as a specific shape (such as the external profile of the battery cell 21). In some embodiments of the present disclosure, the contoured groove 106 is a groove formed in the casing 10, and matches the external profile of the battery cell 21. That is, a shape, dimension, and profile of the contoured groove 106 are completely or substantially the same as a shape, dimension, and profile of the battery cell 21. The formation of the contoured groove 106, on the one hand, can facilitate mounting and positioning of the battery cell 21 in the casing 10. On the other hand, it can limit the mounting of the battery cell 21 in the casing 10, prevent the battery cell 21 from shaking, and improve the mounting stability of the battery cell 21 in the casing 10. In addition, the contoured groove 106 in the present disclosure may be a groove structure, and may be substantially in a semi-circular arc shape. In this way, the contoured groove 106 and the side surface of the battery cell 21 can form a surface contact, enabling the contoured groove 106 to adapt to battery cells 21 of different diameters. For example, the contoured groove 106 may be adapted for mounting a cylindrical battery cell with a diameter of 18 mm, a cylindrical battery cell with a diameter of 21 mm, or the like.

The fixing member 22 is a structure in the battery module used to fix and protect the battery cell 21, which can achieve physical fixation of the battery cell 21, so that the plurality of battery cells 21 are fixed in the casing in a predetermined arrangement, preventing displacement or vibration of the battery cell 21. A material of the fixing member 22 includes, but is not limited to, plastic, metal, and a composite material. The connection between the fixing member 22 and the casing 10 may be a detachable connection. The detachable connection may be a threaded connection, a snap-fit connection, or a combination of the threaded connection and the snap-fit connection.

The fixing slot 221 is a slot structure on the fixing member 22 used to fix the battery cell 21. The fixing slot 221 can not only play a role in mounting and fixing the battery cell 21 but also reduce a dimension of a space occupied by the fixing member 22 and the battery cell 21 together, which is beneficial to the realization of the miniaturization of the battery module 20. When the battery cell 21 is a cylindrical battery cell, the fixing slot 221 may be a cylindrical slot adapted to the battery cell 21. In some embodiments, a diameter of the cylindrical slot is equal to a diameter of the battery cell 21, enabling the battery cell 21 to be fix ed in the cylindrical slot. In other embodiments, the diameter of the cylindrical slot may be slightly smaller than the diameter of the battery cell 21, thereby increasing a fixing strength through an interference fit with the battery cell 21. The diameter of the cylindrical slot may be specifically defined based on the diameter of the battery cell 21, and the present disclosure does not specifically limit this. It can be understood that the fixing slot 221 may also be configured in a triangular shape, a polygonal shape, or other irregular shapes, provided that a diameter of its maximum inscribed circle satisfies the above conditions. In addition, when the battery cell 21 is a square battery cell, a shape of the fixing slot 221 is also in a corresponding square shape.

The limiting member 23 is a structure in the battery module 20 used to fix and protect the battery cell 21. It can achieve the physical fixation of the battery cell 21, so that a plurality of battery cells 21 are fixed in the casing in a predetermined arrangement, preventing the displacement or vibration of the battery cell 21. A material of the limiting member 23 includes, but is not limited to, plastic, metal, a composite material, or the like. The connection between the limiting member 23 and the casing 10 may be a detachable connection. The detachable connection may be a threaded connection, a snap-fit connection, or a combination of the threaded connection and the snap-fit connection.

The limiting portion 231 is the main structure on the limiting member 23. The limiting slot 2311 is a slot structure on the limiting portion 231 used to fix the battery cell 21, and may be a slot manufactured as a specific shape (such as the external profile of the battery cell 21). Specifically, the limiting portion 231 may be engaged with the side surface of the battery cell 21 through the limiting slot 2311 to achieve the mounting and positioning of the battery cell 21, preventing the battery cell 21 from moving or shaking when subjected to vibration or impact, and improving the stability of an overall structure of the energy storage power supply 100. Moreover, the formation of the limiting slot 2311 can also reduce a dimension of a space occupied by the limiting member 23 and the battery cell 21 together, which is beneficial to the realization of the miniaturization of the battery module 20.

In some embodiments of the present disclosure, the assembly steps of the battery module 20 and the casing 10 may include: first, mounting the battery cell 21 in the fixing slot 221; then, connecting the fixing member 22 to the casing 10; and finally, connecting the limiting member 23 to the casing 10, thereby completing the assembly of the battery module 20 on the casing 10. Compared with the related art, it is not necessary to fix both ends of the battery cell 21 to two supports, and then connect the two supports to the casing 10, respectively. In this way, the assembly steps in this embodiment save at least one assembly process of the battery cell 21 and the support, which is beneficial to improving the assembly efficiency. It should be noted that the assembly steps of the battery module 20 and the casing 10 in the above embodiments are merely exemplary. In other embodiments, the assembly steps of the battery module 20 and the casing 10 may further include other steps, and further examples are omitted here.

Referring to FIG. 6 and FIG. 7, in some embodiments, the casing 10 is provided with a support portion 19 having the contoured groove 106.

In this way, the fixing member 22 and the limiting member 23 can fix the two opposite ends of the battery cell 21 in the lengthwise direction of the battery cell 21, respectively. In this way, it can be ensured that the battery cell 21 can be stably mounted in the casing 10. In some embodiments, one support portion 19 is provided, and is a protrusion structure disposed on an inner side surface of the casing 10, and has a plurality of contoured grooves 106. In other embodiments, a plurality of support portions 19 are provided, and correspond to the plurality of battery cells 21 in one-to-one correspondence. Moreover, the support portion 19 is of a protrusion structure disposed on the inner side surface of the casing 10, and has a plurality of contoured grooves 106.

In some embodiments of the present disclosure, the plurality of support portions 19 are provided. Each support portion 19 includes two support plates 191 spaced apart from one another and an arc-shaped plate 193. The support plates 191 are connected to the casing 10. Two opposite ends of the arc-shaped plate 193 are connected to the two support plates 191, respectively. The contoured groove 106 is formed by a recess of an arc-shaped surface of the arc-shaped plate 193. It should be noted that, in some embodiments, a plurality of arc-shaped plates 193 are integrally formed. In other embodiments, the plurality of arc-shaped plates 193 are separately formed. The arc-shaped plate 193 is a curved plate with a specific radius of curvature (such as a metal stamped part or an injection molded part), and its arc-shaped surface may be recessed inwardly or protrude outwardly. In the present disclosure, the arc-shaped surface may be recessed inwardly towards a gap between the two support plates 191.

In this way, compared with a case where the support portion 19 is of a solid protrusion structure, the support portion 19 requires less material for molding, which can not only reduce production costs, but also reduce a weight of the casing 10. In addition, the support plate 191 may also serve as a reinforcing rib of the casing 10, which increases a structural strength of the casing 10, reduces the possibility of deformation and damage of the casing 10, and ensures stable operation of the energy storage power supply 100.

In some embodiments, the support plate 191 and the casing 10 are integrally formed That is, the support plate 191 and the casing 10 may be an integral structure manufactured by an integral molding process. In this way, a connection gap and a weak point between the support plate 191 and the casing 10 can be reduced, and thus the possibility of separation between the support plate 191 and the casing 10 can be reduced, which is beneficial to the improvement of the operational stability and reliability of the energy storage power supply 100, while simplifying the manufacturing process. In other embodiments, the support plate 191 and the casing 10 are separately formed, and may be connected into a whole by welding, bonding, snap-fitting, or other connection manners.

In some embodiments, the support plate 191 and the arc-shaped plate 193 are integrally formed. That is, the support plate 191 and the arc-shaped plate 193 may be an integral structure manufactured by an integral molding process. In this way, a connection gap and a weak point between the support plate 191 and the arc-shaped plate 193 can be reduced, and thus the possibility of separation between the support plate 191 and the arc-shaped plate 193 can be reduced, which is beneficial to the improvement of the mounting stability of the battery module 20 in the casing 10. In other embodiments, the support plate 191 and the arc-shaped plate 193 are separately formed, and may be connected into a whole by welding, bonding, snap-fitting, or other connection manners.

Referring to FIG. 6 and FIG. 7, in some embodiments, the casing 10 has a mounting seat 13, the energy storage power supply 100 includes a second fastener, and the battery module 20 includes a first battery module 201 and a second battery module 203. The first battery module 201 includes a first fixing member 221 provided with a plurality of first connection sheets 2221, and the second battery module 203 includes a second fixing member 227 provided with a plurality of second connection sheets 2225. The plurality of first connection sheets 2221 and the plurality of second connection sheets 2225 are arranged and engaged in one-to-one correspondence and are stacked on the mounting seat 13. The second fastener is configured to pass through the plurality of first connection sheets 2221 and the plurality of second connection sheets 2225 and is fixed to the mounting seat 13.

The mounting seat 13 is a partial structure disposed on the inner side surface 105 of the casing 10, which can provide mechanical support, connection positioning, and other functions for other components. The provision of the mounting seat 13 can also improve the structural strength of the casing 10 and reduce the possibility of the deformation and damage of the casing 10. The mounting seat 13 includes, but is not limited to, a boss, a threaded sleeve, or the like. The first connection sheet 2221 is a part of the first fixing member 221 used to be connected to the casing 10. The second connection sheet 2225 is a part of the second fixing member 227 used to be connected to the casing 10. The second fastener may be a threaded fastener (such as a bolt or a screw), a rivet, a pin, or the like. In the present disclosure, as an example, the second fastener is taken as a threaded fastener for illustration. In this way, the first connection sheet 2221 and the second connection sheet 2225 can be detachably fixed on the mounting seat 13 by the second fastener, which can facilitate disassembly, assembly, and maintenance of the battery module 20.

Specifically, the first connection sheet 2221 and the second connection sheet 2225 are stacked on the mounting seat 13, and the second fastener may penetrate the first connection sheet 2221 and the second connection sheet 2225 to be fixed on the mounting seat 13. That is, the second fastener may simultaneously fix the first connection sheet 2221 and the second connection sheet 2225 on the mounting seat 13 through a single locking operation, to achieve assembly of the first battery module 201 and the second battery module 203 in the casing 10, effectively simplifying the assembly steps, and improving the assembly efficiency. Meanwhile, the number of required second fasteners can also be reduced, lowering the production cost. In addition, the stacking of the first connection sheet 2221 and the second connection sheet 2225 on the mounting seat 13 can also reduce a space occupied by the first battery module 201 and the second battery module 203 in a transverse direction (a direction perpendicular to a stacking direction), which is beneficial to the realization of the miniaturization of the energy storage power supply 100. It should be noted that the stacking direction of the first connection sheet 2221 and the second connection sheet 2225 may be parallel to the third direction Z.

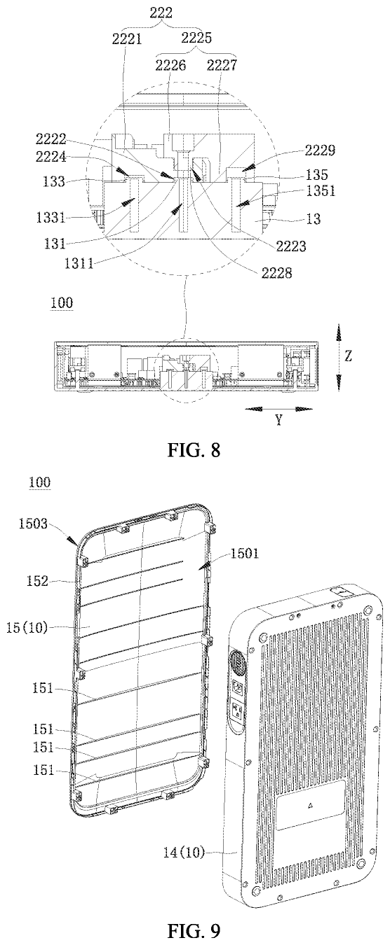

Referring to FIG. 8, in some embodiments, the first connection sheet 2221 is stacked on the mounting seat 13. The second connection sheet 2225 includes a stacking region 2226 and a thickened region 2227. The stacking region 2226 is stacked on the first connection sheet 2221, and the thickened region 2227 is connected to the stacking region 2226 and abuts against the mounting seat 13.

That is, the second connection sheet 2225 is supported on the first connection sheet 2221 through the stacking region 2226, and is supported on the mounting seat 13 through the thickened region 2227. In this way, compared with a case in the related art where the second connection sheet 2225 has a part supported on the first connection sheet 2221 and another part suspended (spaced apart from the mounting seat 13), the arrangement in this embodiment significantly increases a support area of the second connection sheet 2225. When the second connection sheet 2225 is subjected to an impact force due to a drop or collision of the energy storage power supply 100, the possibility of fracture of the second connection sheet 2225 is smaller, which can effectively improve the mounting stability of the battery module 20 in the casing 10.

In some embodiments, a mounting hole 1311 is formed on the mounting seat 13. The second fastener is fixed in the mounting hole 1311 after passing through the second connection sheet 2225 and the first connection sheet 2221.

Specifically, in some embodiments, the second fastener may be a threaded fastener, and the mounting hole 1311 may be a threaded hole. The second fastener may be locked in the mounting hole 1311 after passing through the second connection sheet 2225 and the first connection sheet 2221 sequentially, to detachably fix the second connection sheet 2225 and the first connection sheet 2221 on the mounting seat 13. In this way, disassembly, assembly, and maintenance of the first battery module 201 and the second battery module 203 can be facilitated.

In some embodiments, a first engagement portion 2222 is provided on the first connection sheet 2221. The mounting seat 13 includes a mounting portion 131, and the mounting hole 1311 is formed on the mounting portion 131. The mounting portion 131 is correspondingly engaged with the first engagement portion 2222.

The first engagement portion 2222 may be recessed from a side of the first connection sheet 2221 facing the mounting seat 13 towards a direction away from the mounting seat 13. The mounting portion 131 may be a threaded sleeve, and the mounting hole 1311 is formed on the threaded sleeve. Specifically, the mounting portion 131 is correspondingly engaged with the first engagement portion 2222. That is, the mounting portion 131 may extend into the first engagement portion 2222. In this way, mounting and positioning of the first connection sheet 2221 on the mounting seat 13 can be facilitated, improving the assembly efficiency.

In some embodiments, the mounting seat 13 has an assembly groove. A first reinforcing rib and at least one second reinforcing rib are connected in the assembly groove. The first reinforcing rib and the second reinforcing rib intersect with each other, and the mounting portion 131 is disposed at an intersection between the first reinforcing rib and the second reinforcing rib. In this way, a structural strength of the mounting portion 131 can be significantly improved, the possibility of deformation and damage of the mounting portion 131 can be reduced, and a stable connection of the connection sheet 222 on the mounting seat 13 can be ensured.

In some embodiments, the first connection sheet 2221 is further provided with a fifth engagement portion 2223 corresponding to the first engagement portion 2222, and the second connection sheet 2225 is provided with a second engagement portion 2228 protruding from the second connection sheet 2225. The second engagement portion 2228 is correspondingly engaged with the fifth engagement portion 2223.

Specifically, the fifth engagement portion 2223 may be recessed from a side of the first connection sheet 2221 facing away from the mounting seat 13 in a direction towards the mounting seat 13. The second engagement portion 2228 may protrude and extend from a side of the stacking region 2226 of the second connection sheet 2225 facing the mounting seat 13 in the direction towards the mounting seat 13, and extend into the fifth engagement portion 2223. In this way, preliminary positioning can be achieved when the first connection sheet 2221 and the second connection sheet 2225 are stacked, improving mounting accuracy and the assembly efficiency. The second fastener may be connected in the mounting hole 1311 after passing through the stacking region 2226, the second engagement portion 2228, the fifth engagement portion 2223, and the first engagement portion 2222.

In some embodiments, the first connection sheet 2221 is provided with a third engagement portion 2224, and the second connection sheet 2225 is provided with a fourth engagement portion 2229. The mounting seat 13 includes a first positioning portion 133 and a second positioning portion 135. The first positioning portion 133 is correspondingly engaged with the third engagement portion 2224, and the second positioning portion 135 is correspondingly engaged with the fourth engagement portion 2229.

The third engagement portion 2224 may be recessed from the side of the first connection sheet 2221 facing the mounting seat 13 towards the direction away from the mounting seat 13. The fourth engagement portion 2229 may be recessed from a side of the thickened region 2227 of the second connection sheet 2225 facing the mounting seat 13 towards the direction away from the mounting seat 13. Both the first positioning portion 133 and the second positioning portion 135 may be threaded sleeves. Specifically, the first positioning portion 133 is correspondingly engaged with the third engagement portion 2224. That is, the first positioning portion 133 may extend into the third engagement portion 2224, which can facilitate the mounting and positioning of the first connection sheet 2221 on the mounting seat 13. The second positioning portion 135 may extend into the fourth engagement portion 2229, which can facilitate mounting and positioning of the second connection sheet 2225 on the mounting seat 13.

In some embodiments, the first positioning portion 133 has a first positioning hole 1331, and the second positioning portion 135 has a second positioning hole 1351. The mounting hole 1311 is located between the first positioning hole 1331 and the second positioning hole 1351, and the mounting hole 1311, the first positioning hole 1331, and the second positioning hole 1351 are arranged at intervals. The energy storage power supply 100 further includes a first locking member and a second locking member. The first locking member is fixed in the first positioning hole 1331 after passing through the first connection sheet 2221. The second locking member is fixed in the second positioning hole 1351 after passing through the second connection sheet 2225.

That is, the first locking member and the second fastener jointly fix the first connection sheet 2221 on the mounting seat 13, and the second locking member and the second fastener jointly fix the second connection sheet 2225 on the mounting seat 13. In this way, mounting and fixing stability of the first connection sheet 2221 and the second connection sheet 2225 on the mounting seat 13 can be improved. Moreover, the first positioning hole 1331 is spaced apart from the mounting hole 1311, which can effectively prevent the first connection sheet 2221 from deflecting relative to the mounting seat 13, enhancing connection stability. Similarly, the second positioning hole 1351 is spaced apart from the mounting hole 1311, which can effectively prevent the second connection sheet 2225 from deflecting relative to the mounting seat 13, enhancing the connection stability.

In other embodiments, the first positioning portion 133 has a first positioning hole 1331, and the second positioning portion 135 has a second positioning hole 1351. Moreover, the first positioning hole 1331 and the second positioning hole 1351 do not serve a connection function, but are process holes formed by a core-out process. The formation of the first positioning hole 1331 and the second positioning hole 1351 can avoid excessive wall thicknesses of the first positioning portion 133 and the second positioning portion 135, which is prone to generating internal bubbles. In this way, structural stability of the first positioning portion 133 and the second positioning portion 135 can be improved.

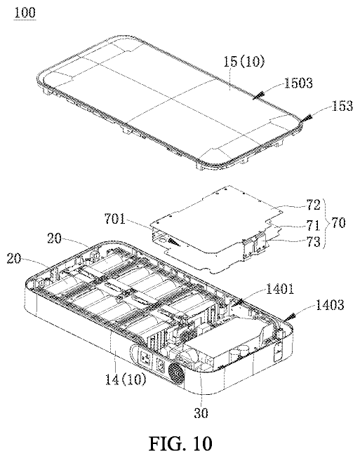

Referring to FIG. 7, FIG. 9, and FIG. 10, in some embodiments, the casing 10 includes a first housing and a second housing. The first housing has a receiving groove 1401 with an opening 1403. The battery module 20 is received in the receiving groove 1401. The first housing and the second housing are fixedly connected and seal the opening 1403. The second housing includes a back surface 1501 facing the first housing and provided with a reinforcing rib 151. An orthographic projection of the reinforcing rib 151 on the battery module 20 is located between two adjacent battery cells 21. It should be noted that the first housing in this embodiment is a bottom housing 14 in the present disclosure, and the second housing is a panel 15 in the present disclosure. For ease of understanding, the following embodiments take an example for description where the first housing is the bottom housing 14, and the second housing is the panel 15.

A shape of the receiving groove 1401 may be a cuboid. The shape and a dimension of the receiving groove 1401 may be determined based on the shape and dimension of the battery module. The opening 1403 is an opening structure for receiving devices such as the battery module into the receiving groove 1401. The panel 15 may be generally of a plate-like structure. When the panel 15 is connected to the bottom housing 14, the panel 15 may seal the opening 1403 to form a closed space in the receiving groove 1401, which can improve a protection effect of the casing 10 on devices such as the battery module. The bottom housing 14 and the panel 15 may be made of the same material or different materials. A connection between the bottom housing 14 and the panel 15 may be a detachable connection or a non-detachable connection. The detachable connection includes, but is not limited to, a screw connection, a snap-fit connection, or a combined connection of the screw connection and the snap-fit connection. The non-detachable connection includes, but is not limited to, an adhesive connection, welding, or a combined connection of the adhesive connection and welding. In some embodiments of the present disclosure, the bottom housing 14 and the panel 15 are fixedly connected in the third direction Z.

Specifically, the reinforcing rib 151 is a protruding rib located on a back surface 1501 of the panel 15. The reinforcing rib 151 can improve a structural strength and a deformation resistance capability of the panel 15, reduce the possibility of deformation and damage of the panel 15, prolong a service life of the panel 15, and ensure normal operation of the energy storage power supply 100. Moreover, in some embodiments of the present disclosure, in consideration of making the energy storage power supply 100 as thin as possible, a spacing between the panel 15 and the battery module 20 is relatively small. The orthographic projection of the reinforcing rib 151 on the battery module 20 is located between two adjacent battery cells 21. In this way, when the panel 15 is deformed, the reinforcing rib 151 can extend into a gap between the two adjacent battery cells 21, which avoids the occurrence of rigid collision between the reinforcing rib 151 and the battery cells 21, causing damage to the battery cells 21. In this way, a service life of the battery cell 21 can be prolonged, and the use safety of the energy storage power supply 100 can be ensured.

In some embodiments, the panel 15 is perpendicular to the third direction Z. Specifically, in some embodiments, the dimension of the casing 10 in the first direction X, the dimension of the casing 10 in the second direction Y, and the dimension of the casing 10 in the third direction Z gradually decrease. At this time, the panel 15 is perpendicular to the third direction Z, i.e., the panel 15 is a major surface structure of the casing 10. In this way, the provision of the reinforcing rib 151 can effectively prevent deformation and damage to the panel 15, ensuring structural stability of the casing 10.

It should be additionally noted that, in some embodiments, the panel 15 being perpendicular to the third direction Z is not strictly limited to the panel 15 being completely perpendicular to the third direction Z, allowing for a certain angular deviation. That is, due to a manufacturing tolerance, an assembly error, or material deformation, an angle between the panel 15 and the third direction Z may have a certain range of deviation. It can be understood that the panel 15 may have a recess 153 or a protrusion.

In some embodiments, the plurality of first battery cells 211 and the plurality of second battery cells 213 are arranged symmetrically. A projection of the reinforcing rib 151 in the third direction Z is located between projections of two adjacent first battery cells 211 in the third direction Z, and between projections of two adjacent second battery cells 213 in the third direction Z simultaneously.

That is, a single reinforcing rib 151 is arranged to directly face a gap between two adjacent first battery cells 211 as well as a gap between two adjacent second battery cells 213. Therefore, compared with a case where one reinforcing rib is respectively disposed corresponding to the gap between two adjacent first battery cells 211 and the gap between two adjacent second battery cells 213, the reinforcing rib 15 in this embodiment features a more continuous structure. That is, no partition exists between a region of the reinforcing rib 151 corresponding to the first battery module 201 and a region of the reinforcing rib 151 corresponding to the second battery module 203. The reinforcing rib 151 is an integral rib, which enables the reinforcing rib 151 to transmit a load more effectively and reduce the deformation of the panel 15.

In some embodiments, a plurality of reinforcing ribs 151 are provided and arranged at intervals in the first direction X. In this way, the structural strength and a bending resistance capability of the panel 15 can be further improved, the possibility of the deformation and damage of the panel 15 can be reduced, the service life of the panel 15 can be prolonged, and the normal operation of the energy storage power supply 100 can be ensured.

In some embodiments, the plurality of reinforcing ribs 151 are provided, and sides of the plurality of reinforcing ribs 151 close to the battery module in the third direction Z are flush. In this way, mounting interference of the panel 15 caused by a local protrusion can be avoided. That is, a dimension of any reinforcing rib 151 in the third direction Z can be prevented from being excessively large, which avoids abutment of the panel 15 with the battery module when the panel 15 is mounted, causing warping of the panel 15. Thus, mounting stability of the panel 15 can be effectively improved.

Referring to FIG. 9 and FIG. 10, in some embodiments, the panel 15 further includes a front surface 1503 facing away from the back surface 1501. An edge of the front surface 1503 is recessed to form a bending portion 152 and a groove 153 located on the front surface 1503. Two opposite ends of the reinforcing rib 151 are connected to the bending portion 152.

The provision of the bending portion 152 enables the panel 15 to form a structure similar to a rolled edge, which increases a thickness of the panel 15 without increasing the amount of material used, and increases inertia moment of the panel 15. In this way, bending resistance and torsion resistance capacities of the panel 15 can be significantly enhanced, and the possibility of the deformation and damage of the panel 15 can be reduced. The two opposite ends of the reinforcing rib 151 are connected to the bending portion 152. In this way, when the panel 15 is subjected to a force, the force can be transmitted from a center to edges of the panel 15, avoiding stress concentration and preventing damage to the panel 15.

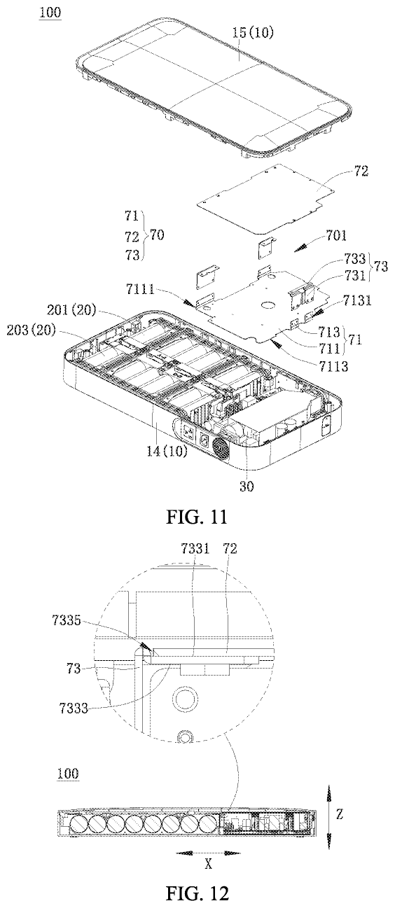

Referring to FIG. 10 and FIG. 11, in some embodiments, the energy storage power supply 100 further includes a protection cover 70. The protection cover 70 is disposed in the casing 10 and includes a bottom plate 71, a top plate 72, and a side plate 73. The bottom plate 71 is detachably connected to the top plate 72 through the side plate 73. The bottom plate 71, the top plate 72, and the side plate 73 collectively enclose a shielding space 701. The inverter 30 is disposed in the shielding space 701, and the protection cover 70 is configured to electromagnetically isolate the inverter 30.

In this way, the provision of the protection cover 70 can shield radiation interference generated by the inverter 30, avoid an influence of electromagnetic interference on other components, and ensure the operational stability of the energy storage power supply 100. In addition, the bottom plate 71, the top plate 72, and the side plate 73 are separately formed. Compared with a case where the protection cover 70 is integrally formed, the protection cover 70 does not interfere with mounting of the inverter 30, and mounting and maintenance of the inverter 30 can be facilitated.

The protection cover 70 is a structure in the energy storage power supply 100 that serves functions of electromagnetic radiation shielding, mechanical protection, and environmental isolation, which can ensure safe and stable operation of the inverter 30 and other electrical components of the energy storage power supply 100. For example, the protection cover 70 can provide electromagnetic shielding (EMI protection) to prevent the electromagnetic interference (EMI) generated by the inverter 30 from affecting surrounding electrical components. The protection cover 70 may be made of at least one of materials, such as aluminum alloy, steel, stainless steel, and aluminum-magnesium alloy. In some embodiments of the present disclosure, the battery module 20 and the protection cover 70 are laid flat in the casing 10 along the length direction X of the casing 10. Moreover, projections of the two battery modules 20 on the protection cover 70 overlap with the protection cover 70, or a degree of overlap between the projections of the two battery modules 20 on the protection cover 70 and the protection cover 70 is greater than 80%.

The bottom plate 71 is a bottom support structure of the protection cover 70 and may be directly connected to the casing 10. The top plate 72 is a top covering member of the protection cover 70, and is connected to the side plate 73 of the protection cover 70 to form an upper enclosure of the shielding space 701. The side plate 73 is a structure connecting the bottom plate 71 and the top plate 72, forming a surrounding enclosure of the protection cover 70 and providing lateral protection. The bottom plate 71, the top plate 72, and the side plate 73 may be made of the same material or different materials. In some embodiments, assembly steps of the protection cover 70 and the inverter 30 may include: first, connecting the bottom plate 71 to the casing 10; then, connecting the inverter 30 to the bottom plate 71; subsequently, connecting the side plate 73 to the bottom plate 71; and finally, connecting the top plate 72 to the side plate 73, thereby completing the assembly of the protection cover 70 and the inverter 30. In this way, the mounting of the inverter 30 in the protection cover 70 is completed during the assembly process of the protection cover 70, and the protection cover 70 does not interfere with the mounting of the inverter 30. It should be noted that the assembly steps of the protection cover 70 and the inverter 30 in the above embodiments are merely exemplary. In other embodiments, the assembly steps of the protection cover 70 and the inverter 30 may take other forms, and further examples are omitted here.

Referring to FIG. 2, in some embodiments of the present disclosure, the BMS protection board is integrated with the inverter 30, and the BMS protection board and the inverter 30 are jointly mounted and fixed in the shielding space 701. It should be noted that, when the airflow in the heat dissipation channel 101 performs heat dissipation on the inverter 30, the airflow in the heat dissipation channel 101 can also perform heat dissipation on the BMS protection board, which prevents the BMS protection board from being damaged by overheating and improves the operational stability and reliability of the energy storage power supply 100.

In some embodiments, the bottom plate 71 includes a main plate 711 and an extending plate 713 bent and extended from an edge of the main plate 711. The main plate 711 is connected to the casing 10. The extending plate 713 is perpendicular to the main plate 711 and is connected to the side plate 73. Moreover, the main plate 711, the extending plate 713, the side plate 73, and the top plate 72 collectively enclose the shielding space 701.

The extending plate 713 is formed by bending and extending from the edge of the main plate 711. The extending plate 713 is capable of providing a connection position for the side plate 73 to connect to the bottom plate 71. Compared with the bottom plate 71 without the extending plate 713, there is no need to additionally mount an auxiliary connection member (such as angle steel) on the bottom plate 71, which simplifies the assembly steps and improves the assembly efficiency. In addition, the extending plate 713 is perpendicular to the main plate 711, and is in a flat plate structure. In this way, compared with a case where the extending plate 713 is of a non-flat plate structure, after the bottom plate 71 is connected to the casing 10 through the main plate 711, the extending plate 713 does not hinder the mounting of the inverter 30, which can facilitate receiving the inverter 30 into the bottom plate 71.

Referring to FIG. 11, in some embodiments, the main plate 711 includes a first edge 7111 and a second edge 7113 facing away from the first edge 7111. At least two extending plates 713 are provided, and are formed on the first edge 7111 and the second edge 7113, respectively. At least two side plates 73 are provided, and are connected to the at least two extending plates 713 in one-to-one correspondence.

Specifically, in some embodiments, in the length direction X of the casing 10, the main plate 711 includes the first edge 7111 and the second edge 7113 facing away from the first edge 7111. The at least two extending plates 713 are formed on the first edge 7111 and the second edge 7113, respectively, and the at least two side plates 73 are connected to the at least two extending plates 713 in one-to-one correspondence. In this way, the at least two side plates 73 can provide multi-point support for the top plate 72, improving structural stability of the protection cover 70. In addition, compared with a case where the extending plate 713 is integrally formed along the edge of the main plate 711, a design of the protection cover 70 in this embodiment uses less material, which not only helps reduce the production cost, but also reduces a weight of the protection cover 70, making the energy storage power supply 100 lighter and more portable.

In some embodiments, the at least two extending plates 713 are two first extending plates 713 and a second extending plate 713, respectively. The two first extending plates 713 are formed on the first edge 7111, and the second extending plate 713 is formed on the second edge 7113. A projection of the second extending plate 713 in a direction from the second edge 7113 to the first edge 7111 is located between the two first extending plates 713. In this way, after the assembly of the protection cover 70 is completed, the side plate 73 can provide three-point support for the top plate 72, making an overall structure of the protection cover 70 more stable. In some embodiments of the present disclosure, the first edge 7111 is closer to the battery module 20 than the second edge 7113. Thus, the formation of the two first extending plates 713 on the first edge 7111 is beneficial to improving an electromagnetic shielding effect and ensuring the operational stability and reliability of the energy storage power supply 100.

In some embodiments, the extending plate 713 includes a first extending surface and a second extending surface facing away from the first extending surface. The first extending surface faces the shielding space 701. The fixing slot 7131 is formed on the first extending surface or the second extending surface, and the side plate 73 is received in the fixing slot 7131. The formation of the fixing slot 7131 can facilitate mounting and positioning of the extending plate 713 on the side plate 73, which is beneficial to the improvement of the assembly efficiency.

In some embodiments, the side plate 73 includes a connection plate 731 and a bending plate 733. The connection plate 731 is connected to the bottom plate 71. The bending plate 733 is bent and extends from an end of the connection plate 731 away from the bottom plate 71, and is configured to support and be connected to the top plate 72. In this way, compared with an arrangement without the bending plate 733, the provision of the bending plate 733 can increase a contact area between the top plate 72 and the side plate 73, which is beneficial to the improvement of the connection stability.

Referring to FIG. 12, in some embodiments, the bending plate 733 includes a support surface 7331 and a bending surface 7333 facing away from the support surface 7331. The support surface 7331 supports the top plate 72. A plurality of side plates 73 are provided, and support surfaces 7331 of the plurality of side plates 73 are flush with each other. In this way, mounting of the top plate 72 on the side plates 73 can be relatively flat, reducing the possibility of deformation and damage of the top plate 72.

In some embodiments, a support groove 7335 is formed on the support surface 7331, and the top plate 72 is received in the support groove 7335. The formation of the support groove 7335 can facilitate pre-mounting and positioning of the top plate 72 on the side plate 73, which is helpful to improve mounting efficiency.

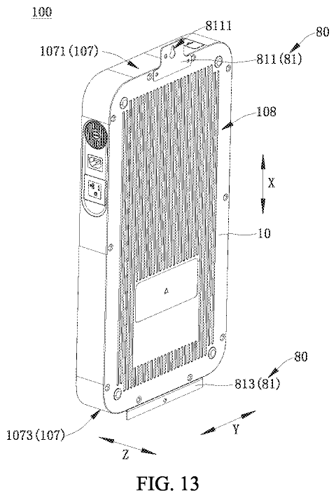

Referring to FIG. 13, in some embodiments, the casing 10 includes two connection end surfaces 107 facing away from each other. The energy storage power supply 100 further includes a hanging assembly 80 configured to hang the casing 10 on an external structure. The hanging assembly 80 includes two hanging members 81. The two hanging members 81 are both connected to the casing 10, and protrude from the two connection end surfaces 107, respectively. It should be noted that, in some embodiments, in the length direction X of the casing 10, the casing 10 includes the two connection end surfaces 107 facing away from each other.

In this way, the energy storage power supply 100 may be mounted on the external structure through the hanging assembly 80, which expands an application scenario of the energy storage power supply 100 and improves user experience. Moreover, it is also possible to prevent the energy storage power supply 100 from occupying excessive floor space, facilitating the layout of other devices or pedestrian traffic. Moreover, the two hanging members 81 protrude from the two connection end surfaces 107, respectively. In this way, the energy storage power supply 100 can be prevented from shaking under stress during mounting, improving mounting stability of the energy storage power supply 100 on the external structure. In addition, the two hanging members 81 can provide redundant safety. When one hanging member 81 is accidentally loosened, the other hanging member 81 can still provide temporary support, reducing a risk of the energy storage power supply 100 falling.

The hanging assembly 80 is a component used to stably hang or fix the energy storage power supply 100 on the external structure. The hanging member 81 is a functional unit of the hanging assembly 80, and is directly connected to the casing 10 of the energy storage power supply 100 and the external structure, to realize the mounting of the energy storage power supply 100 on the external structure. The hanging member 81 may be made of at least one of the materials, such as stainless steel, steel, aluminum alloy, or plastic. The external structure includes, but is not limited to, a wall, a rack, and a pillar. In some embodiments of the present disclosure, the hanging member 81 is detachably connected to the casing 10. In this way, on the one hand, disassembly, assembly, and maintenance of the hanging member 81 can be facilitated. When the hanging member 81 is damaged, the hanging member 81 can be replaced individually, reducing maintenance costs. On the other hand, when the energy storage power supply 100 does not need to be mounted, the hanging member 81 can be disassembled to prevent the hanging member 81 from interfering with storage of the energy storage power supply 100 or its use in other scenarios.

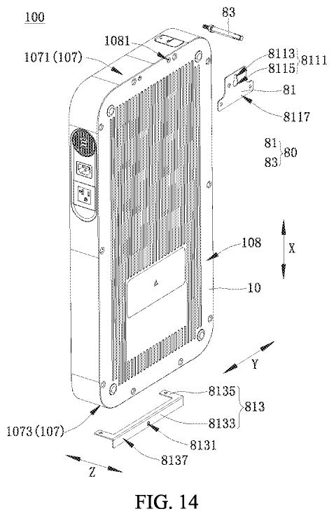

Referring to FIG. 14, in some embodiments, the two connection end surfaces 107 include a first connection end surface 1071 and a second connection end surface 1073. The casing 10 further includes a contact surface 108. The first connection end surface 1071 is connected to the second connection end surface 1073 through the contact surface 108. The two hanging members 81 are a first hanging member 811 and a second hanging member 813, respectively. One of the first hanging member 811 and the second hanging member 813 is connected to the first connection end surface 1071 and/or the contact surface 108, and protrudes from the first connection end surface 1071. The other one of the first hanging member 811 and the second hanging member 813 is connected to the second connection end surface 1073 and/or the contact surface 108, and protrudes from the second connection end surface 1073.

It should be noted that, in some embodiments, the connection end surface 107 may be parallel to a plane defined by the second direction Y and the third direction Z of the casing 10, and the contact surface 108 of the casing 10 may be parallel to a plane defined by the first direction X and the second direction Y of the casing 10. In this way, when the energy storage power supply 100 is mounted on the external structure in the third direction Z, the mounting of the energy storage power supply 100 on the external structure is more stable.

In some embodiments, the first hanging member 811 and the second hanging member 813 are symmetrically distributed, which can disperse the applied force and ensure the mounting stability of the energy storage power supply 100. For example, the first hanging member 811 and the second hanging member 813 are connected to the first connection end surface 1071 and the second connection end surface 1073, respectively. For another example, both the first hanging member 811 and the second hanging member 813 are connected to the contact surface 108, and protrude from the first connection end surface 1071 and the second connection end surface 1073, respectively.

In other embodiments, the first hanging member 811 and the second hanging member 813 are asymmetrically distributed. For example, one of the first hanging member 811 and the second hanging member 813 is connected to the first connection end surface 1071, and the other one of the first hanging member 811 and the second hanging member 813 is connected to the contact surface 108 and protrudes from the second connection end surface 1073. Alternatively, one of the first hanging member 811 and the second hanging member 813 is connected to the second connection end surface 1073, and the other one of the first hanging member 811 and the second hanging member 813 is connected to the contact surface 108 and protrudes from the first connection end surface 1071.

For ease of understanding, the following embodiments take an example for description where the first hanging member 811 is connected to the contact surface 108 and protrudes from the first connection end surface 1071, and the second hanging member 813 is connected to the second connection end surface 1073 and protrudes from the second connection end surface 1073. In this case, when the energy storage power supply 100 is mounted on the external structure, the first connection end surface 1071 is located above the second connection end surface 1073.

Referring to FIG. 13 and FIG. 14, in some embodiments, a first locking hole 1081 is formed on the contact surface 108. The energy storage power supply 100 further includes a third locking member configured to be fixed in the first locking hole 1081 after passing through the first hanging member 811. A first hanging hole 8111 is formed on the first hanging member 811. An orthographic projection of the casing 10 on the first hanging member 811 is spaced apart from the first hanging hole 8111. The energy storage power supply 100 further includes a third fastener 83 that passes through the first hanging hole 8111 and is fixed to the external structure.

In this way, the first hanging member 811 is connected to the contact surface 108 through the third locking member, and is fixed to the external structure through the third fastener 83, thereby realizing the mounting of the energy storage power supply 100 on the external structure. Moreover, the orthographic projection of the casing 10 on the first hanging member 811 is spaced apart from the first hanging hole 8111. That is, the first hanging hole 8111 is located in a region of the first hanging member 811 protruding from the connection end surface 107, which can facilitate a mounting operation of the third fastener 83.

In addition, the first hanging hole 8111 may also serve as a positioning point for drilling. That is, after a user mounts the energy storage power supply 100 on the external structure to an ideal position, the first hanging hole 8111 can be used to mark a drilling region. A power screwdriver (or other drilling tools such as an electric drill) can then be used to accurately drill holes, to facilitate subsequent mounting and fixation of the first hanging member 811 and improve positioning accuracy.

In some embodiments, the first hanging member 811 is of a flat plate structure. In this way, the first hanging member 811 can be directly attached to the external structure, which can improve the mounting stability of the energy storage power supply 100 while reducing mounting difficulty.

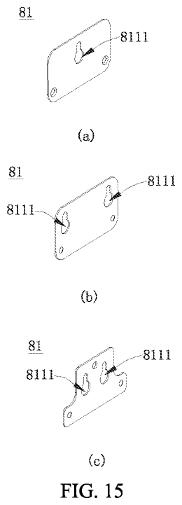

Referring to FIG. 14 and FIG. 15(a), in some embodiments, only one first hanging hole 8111 is included. In this way, mounting of the first hanging member 811 can be made more convenient, realizing quick fixation of the first hanging member 811. It should be noted that, in some embodiments, the first hanging member 811 is connected to a middle region of the contact surface 108 in the width direction Y of the casing 10, and the first hanging hole 8111 is formed on a middle region of the first hanging member 811 in the width direction Y of the casing 10. In this way, tilting of the energy storage power supply 100 during the mounting can be effectively prevented.

Referring to FIG. 15(b) and FIG. 15(c), in other embodiments, at least two first hanging holes 8111 are included and spaced apart from one another. In this way, mounting stability of the first hanging member 811 on the external structure can be improved. Moreover, at least two third fasteners 83 pass through the corresponding first hanging holes 8111 and are fixed to the external structure, which can improve a load-bearing capacity and reduce a possibility of the energy storage power supply 100 falling. It should be noted that, in some embodiments, the first hanging member 811 is connected to the middle region of the contact surface 108 in the width direction Y of the casing 10, and the at least two first hanging holes 8111 are spaced apart from one another on the first hanging member 811 in the width direction Y of the casing 10. In this way, the tilting of the energy storage power supply 100 during the mounting can be effectively prevented.

In some embodiments, the third fastener 83 is an expansion bolt. The first hanging hole 8111 includes a first sub-hole 8113 and a second sub-hole 8115 that are in communication with each other. The first sub-hole 8113 is located above the second sub-hole 8115. The third fastener 83 passes through the first sub-hole 8113 and is fixed to the external structure. A dimension of the second sub-hole 8115 is greater than a maximum diameter of the third fastener 83.

In some embodiments of the present disclosure, during the process of mounting the energy storage power supply 100 through the first hanging member 811, the third fastener 83 may be placed on the external structure. Then, the energy storage power supply 100 is moved, enabling the third fastener 83 to pass through the first hanging hole 8111 via the second sub-hole 8115. Subsequently, the energy storage power supply 100 is moved to make the third fastener 83 enter the first sub-hole 8113. Finally, the third fastener 83 is tightened, thereby mounting the energy storage power supply 100 on the external structure. In this way, during the process of mounting the energy storage power supply 100 through the first hanging hole 8111, there is no need to completely remove a nut and a gasket 92 of the expansion bolt, which is helpful to improve the assembly efficiency.

It should be additionally noted that the expansion bolt may include a nut, a gasket, an expansion pipe, and a bolt. During use, the bolt and the expansion pipe of the expansion bolt may be inserted into a hole of the external structure. Subsequently, the nut is tightened to drive the bolt to extend into the expansion pipe and expand it, thereby fixing the expansion bolt to the external structure. The maximum diameter of the third fastener 83 may be a dimension of the nut and/or the gasket.

In other embodiments, when the third fastener 83 is an internal expansion bolt or a self-tapping expansion bolt, the first hanging hole 8111 may be designed as a single hole, and the third fastener 83 directly passes through the first hanging hole 8111 and is fixed to the external structure.

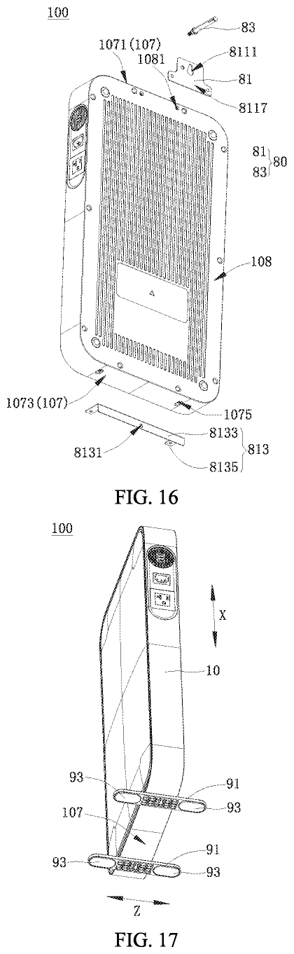

Referring to FIG. 16, in some embodiments, a second locking hole 1075 is formed on the connection end surface 107 (the second connection end surface 1073). The energy storage power supply 100 further includes a fourth locking member configured to be fixed in the second locking hole 1075 after passing through the second hanging member 813. A second hanging hole 8131 is formed on the second hanging member 813. The energy storage power supply 100 further includes a second fastener that passes through the second hanging hole 8131 and is fixed to the external structure.

In this way, the second hanging member 813 is connected to the connection end surface 107 through the fourth locking member, and is fixed to the external structure through the second fastener, thereby realizing the mounting of the energy storage power supply 100 on the external structure. Moreover, the second hanging member 813 is connected to the connection end surface 107. In this way, the second hanging hole 8131 also protrudes from a region of the connection end surface 107, which can facilitate a mounting operation of the second fastener.

In addition, the second hanging hole 8131 may also serve as a positioning point for drilling. That is, after the user mounts the energy storage power supply 100 on the external structure to an ideal position, the second hanging hole 8131 can be used to mark the drilling region. The power screwdriver (or other drilling tools such as the electric drill) can then be used to accurately drill holes, to facilitate subsequent mounting and fixation of the second hanging member 813 and improve the positioning accuracy.

In some embodiments, only one second hanging hole 8131 is included, which can make mounting of the second hanging member 813 more convenient, realizing quick fixation of the second hanging member 813. It should be noted that, in some embodiments, the second hanging member 813 is connected to a middle region of the connection end surface 107 in the width direction Y of the casing 10, and is formed on a middle region of the second hanging member 813 in the width direction Y of the casing 10. In this way, the tilting of the energy storage power supply 100 during the mounting can be effectively prevented.

In other embodiments, at least two second hanging holes 8131 are included and spaced apart from one another. In this way, mounting stability of the second hanging member 813 on the external structure can be improved. Moreover, at least two fourth fasteners pass through the corresponding second hanging holes 8131 and are fixed to the external structure, which can improve the load-bearing capacity and reduce the possibility of the energy storage power supply 100 falling. It should be noted that, in some embodiments, the second hanging member 813 is connected to the middle region of the connection end surface 107 in the width direction Y of the casing 10, and the at least two second hanging holes 8131 are spaced apart from one another on the second hanging member 813 in the width direction Y of the casing 10. In this way, the tilting of the energy storage power supply 100 during the mounting can be effectively prevented.

In some embodiments, the second hanging member 813 includes a hanging plate 8133 and a connection wall 8135 bent and extended from an end of the hanging plate 8133. The second hanging hole 8131 is formed on the hanging plate 8133, and the second locking hole 1075 is formed on the connection wall 8135. The provision of the connection wall 8135 can increase a contact area between the second hanging member 813 and the connection end surface 107, making the connection more stable.

In some embodiments, two connection walls 8135 are included and spaced apart from one another. Each connection wall 8135 has a second locking hole 1075. In this way, compared with a case where the connection wall 8135 is integrally formed by bending and extending from an end of the hanging plate 8133, a dimension of the connection wall 8135 in this embodiment is smaller, which is beneficial to a reduction in material costs and a weight of the second hanging member 813.

In some embodiments, the first hanging member 811 includes a first hanging surface 8117 facing the external structure, and the second hanging member 813 includes a second hanging surface 8137 facing the external structure. The first hanging surface 8117 and the second hanging surface 8137 are flush. In this way, flatness of mounting the energy storage power supply 100 on the external structure can be ensured, improving the mounting stability.

In some embodiments of the present disclosure, when the external structure is a wooden wall, assembly steps of the hanging assembly 80 may include: first, mounting the first hanging member 811 and the second hanging member 813 on the casing 10; then, holding the energy storage power supply 100 against the wooden wall to an ideal position and marking drilling positions (positions corresponding to the first hanging hole 8111 and the second hanging hole 8131); subsequently, driving the third fastener into the wooden wall; thereafter, hanging the energy storage power supply 100 on the wooden wall; then, after checking the verticality, locking the second hanging member 813 to the wooden wall using the fourth fasteners; and finally, tightening the third fasteners to complete the mounting. It should be noted that the assembly steps of the hanging assembly 80 described above are merely exemplary. In other embodiments, the assembly steps of the hanging assembly 80 may further include other procedures, and further examples are omitted here.

In other embodiments of the present disclosure, when the external structure is a concrete wall, the assembly steps of the hanging assembly 80 may include: first, mounting the first hanging member 811 and the second hanging member 813 on the casing 10; then, holding the energy storage power supply 100 against the concrete wall to an ideal position and marking the drilling positions (the position corresponding to the first hanging hole 8111); subsequently, after drilling, loosening the third fastener (expansion bolt) and inserting it into the drilled hole; thereafter, hanging the energy storage power supply 100 on the wall, marking the position corresponding to the second hanging hole 8131 at the bottom after checking the verticality, drilling holes and inserting an expansion bolt with the nut and gasket removed; then, after mounting the energy storage power supply 100 on the wall, slightly lifting the energy storage power supply 100 to align the bottom expansion bolt with the second hanging hole 8131 and inserting the bottom expansion bolt; and finally, tightening the third fastener and the fourth fastener to complete the mounting. It should be noted that the assembly steps of the hanging assembly 80 described above are merely exemplary. In other embodiments, the assembly steps of the hanging assembly 80 may further include other procedures, and further examples are omitted here.

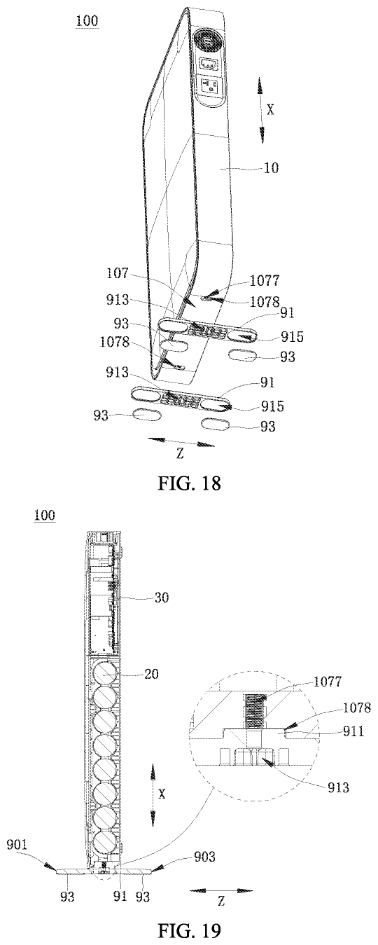

Referring to FIG. 17 to FIG. 19, in some embodiments, the casing 10 includes a connection end surface 107 perpendicular to the first direction X; the energy storage power supply 100 further includes a support bar 91 detachably connected to the connection end surface 107; a length direction of the support bar 91 is parallel to the third direction Z; the support bar 91 includes a first end 901 and a second end 903 that are arranged in the length direction of the support bar 91 and are opposite to each other; and in the first direction Z, a projection of the casing 10, a projection of the first end 901 of the support bar 91, and a projection of the second end 903 of the support bar 91 in the first direction Z are arranged at intervals.

A ratio of a dimension of the casing 10 in the first direction X to a dimension of the casing 10 in the third direction Z is greater than 8, and the connection end surface 107 is perpendicular to the first direction X. Therefore, when the energy storage power supply 100 is placed upright, a dimension of the connection end surface 107 in the third direction Z is relatively small, which leads to an insufficient contact area between the casing 10 and the support surface, forming an unstable structure with a high center of gravity and a narrow support surface. This reduces an anti-tipping capability of the energy storage power supply 100, making it prone to tipping over.

In the embodiments of the present disclosure, the provision of the support bar 91 can increase the contact area between the casing 10 and the support surface (such as the ground), improving placement stability of the energy storage power supply 100. Moreover, an orthographic projection of the casing 10 in the first direction X, an orthographic projection of the first end 901 of the support bar 91 in the first direction X, and an orthographic projection of the second end 903 of the support bar 91 in the first direction X are arranged at intervals. That is, in the length direction of the support bar 91 (parallel to the third direction Z), the first end 901 and the second end 903 of the support bar 91 protrude from the two opposite sides of the casing 10 in the third direction Z, respectively. In this way, balance of the energy storage power supply 100 when placed upright can be made better, which is helpful to satisfy production compliance test requirements (i.e., a safety specification for anti-tipping), preventing the energy storage power supply 100 from accidentally tipping over and causing an electrical short circuit, mechanical damage, or personal injury. Thus, the use safety of the energy storage power supply 100 can be ensured, improving the user experience.

In some embodiments, two support bars 91 are included, and are spaced apart from one another in the second direction Y. In this way, the placement stability of the energy storage power supply 100 on the support surface can be further improved.

In some embodiments, a ratio of the dimension of the casing 10 in the third direction Z to a dimension of the support bar 91 in the length direction of the support bar 91 is greater than or equal to ⅓. That is, in the third direction Z, the ratio of the dimension of the casing 10 to the dimension of the support bar 91 is greater than or equal to ⅓. In this way, anti-tipping moment can be significantly improved to prevent the energy storage power supply 100 from tipping over.

In some embodiments, a connection hole 1077 is formed on the connection end surface 107. The energy storage power supply 100 further includes a fastener configured to be fixed in the connection hole 1077 after passing through the support bar 91. That is, the detachable connection between the support bar 91 and the connection end surface 107 is realized through the fastener, making the assembly between the support bar 91 and the casing 10 convenient and providing a high connection strength. Referring to FIG. 16, it should be noted that the connection hole 1077 in this embodiment may be equivalent to the second locking hole 1075 in the above embodiments. That is, the support bar 91 and the second hanging member 813 share the connection hole. In this way, there is no need to form excessive through holes on the casing 10, ensuring the structural strength and sealing performance of the casing 10.

Referring to FIG. 19, in some embodiments, a positioning slot 1078 is further formed on the connection end surface 107 and corresponds to the connection hole 1077. The support bar 91 further has a positioning protrusion 911 that extends into the positioning slot 1078, and the fastener penetrates the positioning protrusion 911 to be fixed in the connection hole 1077. In this way, the positioning protrusion 911 is engaged with the positioning slot 1078 to facilitate mounting and positioning of the support bar 91 on the connection end surface 107, improving the assembly efficiency.

It should be noted that, in some embodiments, a cross section of the positioning slot 1078 is in a non-circular shape, such as a racetrack shape. A cross section of the positioning protrusion 911 is the same as the cross-section of the positioning slot 1078. In this way, it is possible to prevent the support bar 91 from rotating relative to the casing 10 during the connection process of the fastener, ensuring stable mounting.

In some embodiments, a plurality of weight-reducing grooves 913 are formed on a side of the support bar 91 facing away from the casing 10. At least one of the plurality of weight-reducing grooves 913 corresponds to the positioning protrusion 911. The fastener is fixed in the connection hole 1077 after passing through the weight-reducing groove 913 and the positioning protrusion 911.

On the one hand, the formation of the weight-reducing groove 913 can save a material of the support bar 91, reducing the production cost while reducing a weight of the support bar 91. On the other hand, it is possible to prevent the fastener from protruding from the side of the support bar 91 facing away from the casing 10, ensuring support stability of the support bar 91 on the support surface (such as the ground).

In some embodiments, each of both ends of the support bar 91 in the length direction of the support bar 91 is provided with the gasket 92. The gasket 92 is located on the side of the support bar 91 facing away from the casing 10. A projection of the casing 10 in the first direction X is spaced apart from a projection of the gasket 92 in the first direction X. It should be noted that, in some embodiments, the gasket 92 may be made of at least one of rubber, silicone, and other materials.

The provision of the gasket 92 can not only increase a friction force between the support bar 91 and the support surface, preventing the energy storage power supply 100 from sliding or tipping over on the support surface, but also absorb impact to some extent, protecting the internal components of the energy storage power supply 100 from being damaged. The projection of the casing 10 in the first direction X is spaced apart from the projection of the gasket 92 in the first direction X. In this way, the support bar 91 can provide multi-point support for the casing 10 through the gasket 92, increasing the support area and reducing a risk of the casing 10 tipping over due to a shift of the center of gravity.

In some embodiments, a receiving slot 915 is formed on the support bar 91, and the gasket 92 is at least partially disposed in the receiving slot 915. Specifically, the receiving slot 915 may be recessed from the side of the support bar 91 facing away from the casing 10 towards the casing 10. The formation of the receiving slot 915 can facilitate mounting and positioning of the gasket 92, improving the assembly efficiency.

Referring to FIG. 1(c) to FIG. 19, an embodiment of the present disclosure provides another energy storage power supply 100. The energy storage power supply 100 is in a cuboid shape, and has a thickness smaller than 10 cm and a capacity greater than 0.5 kWh. That is, the dimension of the energy storage power supply 100 in the third direction Z is smaller than 7 cm. In this way, the energy storage power supply 100 can form a thin cuboid, enabling it to better adapt to the scenario with strict mounting space requirements and preventing the use of the energy storage power supply 100 from being limited in a relatively small space, thus improving the applicability of the energy storage power supply 100. Specifically, in some embodiments, the thickness of the casing 10 may be any value smaller than or equal to 10 cm, such as 10 cm, 9 cm, 8 cm, 7.0 cm, 6.5 cm, 6.0 cm, 5.5 cm, 5.0 cm, 4.5 cm, 4.0 cm, 3.5 cm, or 3.0 cm, or any numerical value between any two of these values. The capacity of the energy storage power supply 100 may be any value greater than or equal to 0.5 kWh, such as 0.5 kWh, 0.6 kWh, 0.7 kWh, 0.8 kWh, 0.9 kWh, 1.0 kWh, or 1.1 kWh, or any numerical value between any two of these values.

It should be noted that the structure of the energy storage power supply 100 in this embodiment is substantially the same as that of the energy storage power supply 100 in the above embodiments. Therefore, the explanations of the energy storage power supply 100 in the preceding embodiments are equally applicable to the energy storage power supply 100 in this embodiment. Similarly, the explanations of the energy storage power supply 100 in this embodiment are equally applicable to the energy storage power supply 100 in the preceding embodiments.

Referring to FIG. 1(c) to FIG. 19, an embodiment of the present disclosure further provides yet another energy storage power supply 100. The energy storage power supply 100 is in a cuboid shape. A ratio of a length of the energy storage power supply 100 to a thickness of the energy storage power supply 100 is greater than 8; a ratio of a width of the energy storage power supply 100 to the thickness of the energy storage power supply 100 is greater than 4; and a capacity of the energy storage power supply 100 is greater than 0.5 kWh. In this way, the casing 10 can be generally in the shape of a flat cuboid, preventing the use of the energy storage power supply 100 from being limited in a relatively small space. Moreover, when the energy storage power supply 100 is in a wall-mounted state, the energy storage power supply 100 does not protrude too much relative to the wall-mounted surface (such as a wall), which can improve stability of the wall mounting. Specifically, in some embodiments, the capacity of the energy storage power supply 100 may be any value greater than or equal to 0.5 kWh, such as 0.5 kWh, 0.6 kWh, 0.7 kWh, 0.8 kWh, 0.9 kWh, 1.0 kWh, or 1.1 kWh, or any numerical value between any two of these values. Exemplarily, when the thickness of the casing 10 is 6 cm, the width of the casing 10 may be greater than or equal to 32 cm, and the length of the casing 10 may be greater than or equal to 48 cm.

It should be noted that the structure of the energy storage power supply 100 in this embodiment is substantially the same as that of the energy storage power supply 100 in the above embodiments. Therefore, the explanations of the energy storage power supply 100 in the preceding embodiments are equally applicable to the energy storage power supply 100 in this embodiment. Similarly, the explanations of the energy storage power supply 100 in this embodiment are equally applicable to the energy storage power supply 100 in the preceding embodiments.

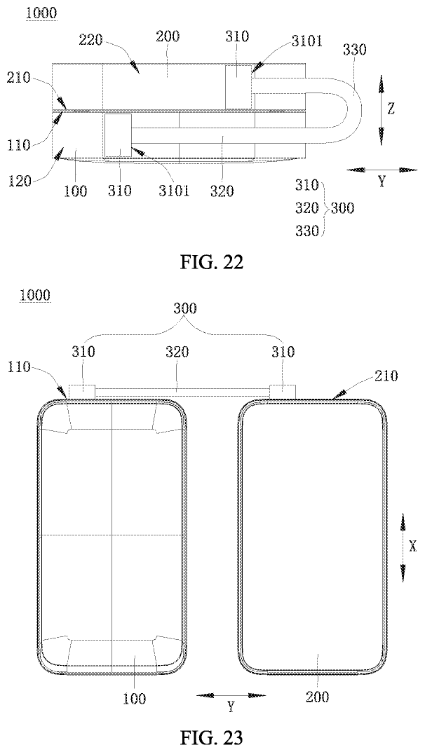

Referring to FIG. 1(c) and FIG. 20, and in conjunction with FIG. 22 and FIG. 23, an embodiment of the present disclosure provides an energy storage power supply system 1000. The energy storage power supply system 1000 includes the energy storage power supply 100 according to any of the above embodiments, a power expansion pack 200, and a cable 300 configured to electrically connect the power expansion pack 200 and the energy storage power supply 100. It should be noted that the energy storage power supply 100 in this embodiment is the same as the energy storage power supply 100 in any of the above embodiments. Therefore, the explanations of the energy storage power supply 100 in the preceding embodiments are equally applicable to the energy storage power supply 100 in this embodiment. Similarly, the explanations of the energy storage power supply 100 in this embodiment are equally applicable to the energy storage power supply 100 in the preceding embodiments.

The power expansion pack 200 is an additional battery pack added to the energy storage power supply system 1000 to expand the capacity. When the energy storage power supply 100 is electrically connected to the power expansion pack 200, a capacity of the energy storage power supply system 1000 increases. Moreover, the greater the number of power expansion packs 200, the higher the capacity of the entire energy storage power supply system 1000.

The cable 300 is a structure in the energy storage power supply system 1000 used to electrically connect the energy storage power supply 100 and the power expansion pack 200, and is mainly used for power transmission or signal communication. Specifically, two opposite ends of the cable 300 are configured to be electrically connected to the energy storage power supply 100 and the power expansion pack 200, respectively, to realize parallel operation of the energy storage power supply 100 and the power expansion pack 200. At this time, the power expansion pack 200 can supply power to the energy storage power supply 100 through the cable 300. In this way, when the capacity or power of the energy storage power supply 100 cannot satisfy the power demand of a high-power load device, the power expansion pack 200 can be electrically connected to the energy storage power supply 100 through the cable 300 to improve an overall power supply capability.

Referring to FIG. 20 to FIG. 23, in some embodiments, the energy storage power supply 100 includes a first contact surface 110 and a first electrical connection port 1201, and the power expansion pack 200 includes a second contact surface 210 and a second electrical connection port 2201. The energy storage power supply 100 and the power expansion pack 200 are configured with a first state (as shown in FIG. 23) and a second state (as shown in FIG. 22). In the first state of the energy storage power supply 100 and the power expansion pack 200, the energy storage power supply 100 or the power expansion pack 200 is mounted on an external structure, and the first contact surface 110 or the second contact surface 210 directly faces the external structure, and in the second state of the energy storage power supply 100 and the power expansion pack 200, the first contact surface 110 and the second contact surface 210 face each other and are stacked; and the cable 300 includes two power connection portions 310 and a connection portion 320. The two power connection portions 310 are connected to the first electrical connection port 1201 and the second electrical connection port 2201, respectively. Each of the two power connection portions 310 includes a lead end 3101. Two opposite ends of the connection portion 320 pass through two lead ends 3101 of the two power connection portions 310 and are electrically connected to the two power connection portions 310, respectively. The two lead ends 3101 directly face each other in the first state of the energy storage power supply 100 and the power expansion pack 200, and the two lead ends 3101 face a same direction in the second state of the energy storage power supply 100 and the power expansion pack 200. It should be noted that the first contact surface 110 in this embodiment may be equivalent to the contact surface 108 in the above embodiments.

The first electrical connection port 1201 may be a power input port of the energy storage power supply 100, and be used for receiving external power. The first electrical connection port 1201 may be a socket or a wiring terminal. The second electrical connection port 2201 may be a power output port of the power expansion pack 200, and be used for supplying power to an external device. The second electrical connection port 2201 may be a socket or a wiring terminal. When the two ends of the cable 300 are electrically connected to the first electrical connection port 1201 and the second electrical connection port 2201, respectively, the power expansion pack 200 can supply power to the energy storage power supply 100 through the cable 300.

In some embodiments of the present disclosure, the energy storage power supply 100 and the power expansion pack 200 are configured with a first state and a second state. That is, the energy storage power supply 100 and the power expansion pack 200 jointly form the first state and the second state. The energy storage power supply 100 and/or the power expansion pack 200 are capable of rotating around a virtual rotation axis to switch between the first state and the second state. It should be noted that, in some embodiments, both the first contact surface 110 and the second contact surface 210 are arranged parallel to each other with respect to the virtual rotation axis.

In this way, the energy storage power supply 100 and the power expansion pack 200 can achieve state switching in a manner similar to “turning pages of a book”. For example, when a book page is opened, i.e., at least one of the energy storage power supply 100 and the power expansion pack 200 is rotated around the virtual rotation axis to move the first contact surface 110 and the second contact surface 210 away from each other, the energy storage power supply 100 and the power expansion pack 200 can be switched from the second state to the first state. When the book page is closed, i.e., at least one of the energy storage power supply 100 and the power expansion pack 200 is rotated around the virtual rotation axis to move the first contact surface 110 and the second contact surface 210 towards each other, the energy storage power supply 100 and the power expansion pack 200 can be switched from the first state to the second state. In this way, the state switching is made relatively simple. Moreover, during the state switching process, there is no need to replace the cable 300, which is beneficial to the improvement of the user experience. It should be additionally noted that the manner of switching between the first state and the second state for the energy storage power supply 100 and the power expansion pack 200 in the above embodiments is merely exemplary. In other embodiments, the manner of switching between the first state and the second state may also include other forms, and further examples are omitted here.

In addition, in combination with the above, in the first state of the energy storage power supply 100 and the power expansion pack 200, the first contact surface 110 and the second contact surface 210 directly face the external structure. At this time, the energy storage power supply 100 and the battery expansion pack 200 may be in a laid-flat state, which can facilitate mounting the energy storage power supply 100 and the battery expansion pack 200 on the external structure (including, but not limited to, a wall, a rack, and a pillar) together, preventing the energy storage power supply 100 and the battery expansion pack 200 from occupying excessive floor space, and facilitating the layout of other devices or the passage of personnel. In the second state of the energy storage power supply 100 and the power expansion pack 200, the first contact surface 110 and the second contact surface 210 face each other and are stacked. At this time, the energy storage power supply 100 and the battery expansion pack 200 may be in a stacked state, which can reduce a dimension of a space jointly occupied by the energy storage power supply 100 and the battery expansion pack 200, and be beneficial to the realization of the miniaturization of the energy storage power supply system 1000.

Specifically, it should be noted that in the second state of the energy storage power supply 100 and the power expansion pack 200, the two lead ends 3101 face opposite directions, i.e., when the energy storage power supply 100 and the battery pack are stacked, the two lead ends 3101 face opposite directions, which causes the cable 300 connecting the two lead ends 3101 to form an approximately “S”-shaped bending structure. That is, after the energy storage power supply 100 and the power expansion pack 200 are switched to the second state, the cable 300 will have at least two bending portions 330, and the at least two bending portions 330 cause an extending direction of the cable 300 to change at least twice. In this case, the cable 300 will generate a relatively large elastic force after being bent multiple times, which can affect a stacking effect of the energy storage power supply 100 and the power expansion pack 200. Moreover, multiple bends easily lead to damage to the cable 300 (such as fatigue of an internal conductor or damage to an insulation layer), affecting a service life of the cable 300. In the embodiments of the present disclosure, in the second state of the energy storage power supply 100 and the power expansion pack 200, the two lead ends 3101 face the same direction, which can enable the cable 300 connecting the energy storage power supply 100 and the power expansion pack 200 to form an approximately “U”-shaped structure. That is, the cable 300 only needs to be bent once during the process of switching the energy storage power supply 100 and the power expansion pack 200 to the second state. In this way, on the one hand, the cable 300 can be prevented from generating an excessively large elastic force due to multiple bends, which can ensure the stacking effect of the energy storage power supply 100 and the power expansion pack 200. On the other hand, the cable 300 can be prevented from being damaged due to multiple bends, which can prolong the service life of the cable 300.

In some embodiments, the cable 300 is integrally formed. That is, the power connection portion 310 and the connecting portion 320 may be an integral structure manufactured by an integral molding process. In this way, a connection gap and a weak point of the cable 300 can be reduced, and the possibility of fracture of the cable 300 can be lowered, which is beneficial to an improvement in stability of the electrical connection between the energy storage power supply 100 and the power expansion pack 200. In other embodiments, the cable 300 is separately formed. That is, the power connection portion 310 and the connecting portion 320 are independently molded components, and may be connected by welding, snap-fitting, or other connection manners to jointly form the cable 300.

In the energy storage power supply system 1000 according to the embodiments of the present disclosure, the energy storage power supply 100 and the power expansion pack 200 are configured with two states when they are electrically connected through the cable 300. Moreover, relative positions of the energy storage power supply 100 and the power expansion pack 200 are different in the two states. In this way, it is beneficial to an increase in applicable scenarios of the energy storage power supply 100 and the power expansion pack 200 when the energy storage power supply 100 and the power expansion pack 200 are used in parallel. Moreover, there is no need to replace the cable 300, improving the user experience.

Referring to FIG. 22 to FIG. 25, in some embodiments, the energy storage power supply 100 further includes a first connection end surface 120 having a first electrical connection port 1201. The power expansion pack 200 further includes a second connection end surface 220 having a second electrical connection port 2201. In both the first state and the second state, the first connection end surface 120 and the second connection end surface 220 face the same direction. The first electrical connection port 1201 is connected to the second electrical connection port 2201 by the cable 300, to electrically connect the energy storage power supply 100 and the power expansion pack 200. It should be noted that the first connection end surface 120 is perpendicular to the first contact surface 110, and the second connection end surface 220 is perpendicular to the second contact surface 210. In addition, the first connection end surface 120 in this embodiment may be equivalent to the first connection end surface 1071 in the above embodiments.

The first electrical connection port 1201 is formed on the first connection end surface 120, and the second electrical connection port 2201 is formed on the second connection end surface 220. In this way, regardless of the state of the energy storage power supply 100 and the power expansion pack 200, the electrical connection between the first electrical connection port 1201 and the cable 300, as well as the electrical connection between the second electrical connection port 2201 and the cable 300, will not be affected, which can improve the stability of the electrical connection between the energy storage power supply 100 and the power expansion pack 200. Similarly, the electrical connection between the first electrical connection port 1201 and the cable 300, as well as the electrical connection between the second electrical connection port 2201 and the cable 300, will not affect the state switching of the energy storage power supply 100 and the power expansion pack 200. In this way, smooth state switching of the energy storage power supply 100 and the power expansion pack 200 can be ensured, and there is no need to replace the cable 300 during the state switching, which simplifies the operation, and improves the user experience.

In some embodiments of the present disclosure, in the first state, the first contact surface 110 and the second contact surface 210 are parallel, and the cable 300 is in a linear state. In the second state, the first contact surface 110 and the second contact surface 210 face each other and are stacked, and the cable 300 has a bending portion 330 that causes the extending direction of the cable 300 to change once.

That is, when the energy storage power supply 100 and the power expansion pack 200 are switched from the first state to the second state, the cable 300 only needs to be bent once. In this way, on the one hand, a state switching operation of the energy storage power supply 100 and the power expansion pack 200 can be made simpler. On the other hand, the cable 300 can be prevented from being damaged due to excessive bending, which is helpful to prolong the service life of the cable 300. It should be noted that the shape of the cable 300 after bending may be U-shaped, V-shaped, arc-shaped, etc., which is not specifically limited in the present disclosure.

In some embodiments, in the second state, a maximum dimension of the cable 300 in the third direction Z is smaller than or equal to a total dimension of the first connection end surface 120 and the second connection end surface 220 in the third direction Z.

In this way, the cable 300 can be prevented from exceeding a range of the first connection end surface 120 and the second connection end surface 220, avoiding interference between the cable 300 and the external structure. This can not only achieve compact wiring, but can also make the layout of the cable 300 on the connection end surfaces more orderly, which is helpful to improve an overall visual effect of the energy storage power supply system 1000.

Referring to FIG. 22 to FIG. 25, in some embodiments, the energy storage power supply 100 includes a first contact surface 110 provided with a plurality of first foot pads 1102, and the power expansion pack 200 includes a second contact surface 210 provided with a plurality of second foot pads 2102. When the energy storage power supply 100 or the power expansion pack 200 is mounted on an external structure, the first contact surface 110 or the second contact surface 210 directly faces the external structure, and the plurality of first foot pads 1102 and the plurality of second foot pads 2102 are in contact with the external structure. The energy storage power supply 100 and the power expansion pack 200 are configured with a first state (as shown in FIG. 23) and a second state (as shown in FIG. 22). In the first state of the energy storage power supply 100 and the power expansion pack 200, the energy storage power supply 100 or the power expansion pack 200 is mounted on an external structure, the first contact surface 110 or the second contact surface 210 directly faces the external structure, and the plurality of first foot pads 1102 and the plurality of second foot pads 2102 are in contact with the external structure. When the energy storage power supply 100 and the power expansion pack 200 are in the second state, the first contact surface 110 and the second contact surface 210 face each other and are stacked, and the plurality of first foot pads 1102 and the plurality of second foot pads 2102 are positioned and engaged with each other in one-to-one correspondence to enable the energy storage power supply 100 and the power expansion pack 200 to be stacked stably.

The first foot pad 1102 is configured to abut against the support surface (such as the ground or a wall) to support the energy storage power supply 100 on the support surface. The provision of the first foot pad 1102 can ensure that the energy storage power supply 100 is spaced apart from the support surface, which can prevent the energy storage power supply 100 from being contaminated. Moreover, depending on the material, the first foot pad 1102 can also achieve functions such as insulation, buffering, and anti-slip. The second foot pad 2102 is configured to abut against the support surface (such as the ground or a wall) to support the power expansion pack 200 on the support surface. The provision of the second foot pads 2102 can ensure that the power expansion pack 200 is spaced apart from the support surface, which can prevent the power expansion pack 200 from being contaminated. Moreover, depending on the material, the second foot pad 2102 can also achieve functions such as insulation, buffering, and anti-slip. It should be noted that an engagement manner between the first foot pad 1102 and the second foot pad 2102 includes, but is not limited to, a snap-fit engagement, a magnetic attraction engagement, a threaded fastening engagement, an insertion engagement, and a sliding rail guiding engagement.

In the energy storage power supply system 1000 according to the embodiments of the present disclosure, the energy storage power supply 100 and the power expansion pack 200 are stably stacked through the one-to-one positioning and engagement between the plurality of first foot pads 1102 and the plurality of second foot pads 2102. In this way, it is possible to effectively prevent relative displacement between the energy storage power supply 100 and the power expansion pack 200, ensure the stability of the electrical connection between the energy storage power supply 100 and the power expansion pack 200, and guarantee stable power supply of the energy storage power supply system 1000.

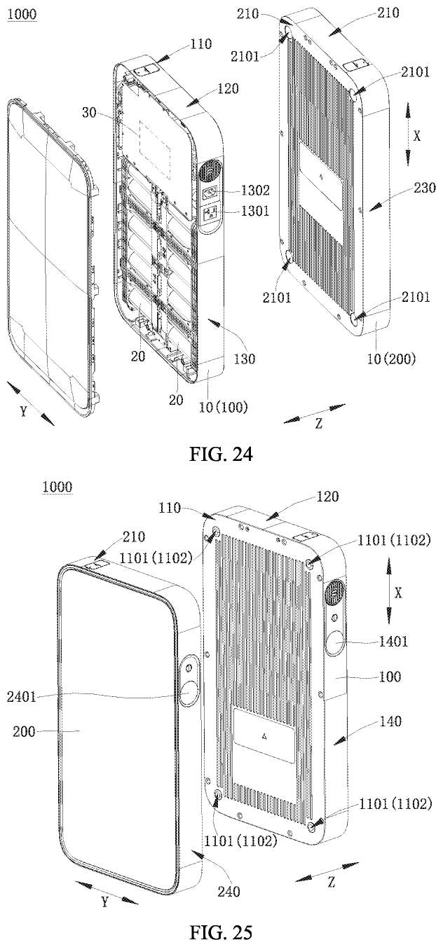

Referring to FIG. 24 and FIG. 25, in some embodiments, a first engagement portion 1101 is formed on the first foot pad 1102, and a second engagement portion 2101 is formed on the second foot pad 2102. The second engagement portion 2101 is correspondingly engaged with the first engagement portion 1101, so that the energy storage power supply 100 and the power expansion pack 200 are stacked while avoiding lateral movement.

Specifically, the first engagement portion 1101 is formed on the first foot pad 1102. That is, the energy storage power supply 100 can reuse the first foot pad 1102 to achieve a mechanical connection with the power expansion pack 200, without the need to additionally arrange connection components, which is beneficial to a reduction in the production cost. Similarly, the second engagement portion 2101 is formed on the second foot pad 2102. That is, the power expansion pack 200 can reuse the second foot pad 2102 to achieve a mechanical connection with the energy storage power supply 100, without the need to additionally arrange the connection components, which is beneficial to the reduction in the production cost.

In some embodiments, one of the first engagement portion 1101 and the second engagement portion 2101 is a groove, and the other one of the first engagement portion 1101 and the second engagement portion 2101 is a protrusion.

That is, the mechanical connection between the energy storage power supply 100 and the power expansion pack 200 is achieved through a concave-convex engagement between the first engagement portion 1101 and the second engagement portion 2101. On the one hand, it can be beneficial to the realization of quick disassembly and assembly, allowing the assembly or separation to be completed without an auxiliary tool, and improving disassembly and assembly efficiency. On the other hand, it is possible to reduce a dimension of a space occupied by the first engagement portion 1101 and the second engagement portion 2101 together, and it is beneficial to an improvement in an integration degree of the energy storage power supply 100 and the power expansion pack 200.

Specifically, in some embodiments, one of the first engagement portion 1101 and the second engagement portion 2101 is a groove that may have a guiding surface, and the other one of the first engagement portion 1101 and the second engagement portion 2101 is a protrusion matched in dimension and dimensions with the groove. When the first engagement portion 1101 and the second engagement portion 2101 are aligned and engaged, the protrusion may slide into the groove along the guiding surface of the groove, thereby forming stable mechanical locking.

In some embodiments, the plurality of first foot pads 1102 are arranged at intervals on a periphery of the first contact surface 110, and the plurality of second foot pads 2102 are arranged at intervals on a periphery of the second contact surface 210.

In this way, the energy storage power supply 100 and the power expansion pack 200 can be stacked together under a synergistic effect of a plurality of sets of first foot pads 1102 and a plurality of sets of second foot pads 2102. Thus, it is possible to enhance the overall connection strength, effectively resist external impacts and vibrations, improve the stability of the connection between the energy storage power supply 100 and the power expansion pack 200, ensure the stability of the electrical connection between the energy storage power supply 100 and the power expansion pack 200, and guarantee the stable power supply of the energy storage power supply system 1000.

Referring to FIG. 24, in some embodiments, the energy storage power supply 100 further includes a first mounting surface 130 parallel to the third direction Z, and the first mounting surface 130 is provided with at least one of an AC output socket 1301 and an AC input port 1302. The power expansion pack 200 further includes a second mounting surface 230 parallel to the third direction Z. In the first state, the first mounting surface 130 and the second mounting surface 230 face each other. It should be noted that, in some embodiments, the first mounting surface 130 may be perpendicular to the first direction X or the second direction Y, and the second mounting surface 230 may be perpendicular to the first direction X or the second direction Y.

The AC output socket 1301 is an output port on the energy storage power supply 100 for providing electrical energy to the power grid or the load. When the AC output socket 1301 is electrically connected to the power grid or the load through the electrical connection member, the electrical energy of the energy storage power supply 100 can be transmitted to the power grid or the load through the electrical connection member. The AC input port 1302 is an access port on the energy storage power supply 100 for receiving the electrical energy. When the AC input port 1302 is electrically connected to the external AC power source, such as the power grid or the electric generator, through the electrical connection member, the electrical energy of the external AC power source can be transmitted to the energy storage power supply 100 through the electrical connection member.

Specifically, in some embodiments of the present disclosure, the first mounting surface 130 may be perpendicular to the second direction Y, and the second mounting surface 230 may be perpendicular to the second direction Y. In this way, on the one hand, compared with a case where at least one of the AC output socket 1301 and the AC input port 1302 is formed on the first connection end surface 120, a routing path of the electrical connection member (the electrical connection member electrically connected to at least one of the AC output socket 1301 and the AC input port 1302) is separated from a routing path of the cable 300, which effectively avoids interference or entanglement, making the wiring of the energy storage power supply 100 and the power expansion pack 200 more orderly and improving the overall visual effect. On the other hand, in the first state, the electrical connection member is located in a structural gap between the energy storage power supply 100 and the power expansion pack 200 without occupying additional space, which significantly improves the integration degree of the energy storage power supply system 1000, while facilitating docking and maintenance of the electrical connection member.

Referring to FIG. 25, in some embodiments, the energy storage power supply 100 further includes a third mounting surface 140 parallel to the third direction Z, and the third mounting surface 140 is provided with a first display screen 1401. The power expansion pack 200 further includes a fourth mounting surface 240 parallel to the third direction Z, and the fourth mounting surface 240 is provided with a second display screen 2401. In the second state, the third mounting surface 140 and the fourth mounting surface 240 face the same direction. In this way, it can be convenient for the user to observe display data on the display screens of both the energy storage power supply 100 and the power expansion pack 200 simultaneously, without the need to change position or flip the energy storage power supply system 1000, improving the user experience. It should be noted that, in some embodiments, the third mounting surface 140 faces away from the first mounting surface 130, and the fourth mounting surface 240 faces away from the second mounting surface 230.

In the description of this specification, descriptions with reference to the terms “certain embodiments”, “an embodiment”, “some embodiments”, “examples”, “specific examples”, or “some examples”, etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality of” means at least two, such as two, three, etc., unless otherwise specifically defined.

Although embodiments according to the present disclosure have been shown and described, it would be appreciated by those skilled in the art that the above embodiments are illustrative and cannot be construed to limitation on the present disclosure, and changes, alternatives, modifications, and variations can be made in the embodiments without departing from scope of the present disclosure. The scope of the present disclosure is defined by the claims as attached and their equivalents.

What is claimed is:

1. An energy storage power supply, comprising:
a casing having a mounting cavity, a mounting wall being formed at an inner wall of the mounting cavity;
a battery module mounted in the mounting cavity, the battery module comprising a plurality of battery cells arranged side by side in a single layer, wherein the plurality of battery cells are laid flat on the mounting wall; and
an inverter mounted in the mounting cavity, wherein the inverter is spaced apart from and electrically connected to the battery module, and wherein the inverter comprises a substrate and a circuit component disposed on the substrate, the substrate being laid flat on the mounting wall.

2. The energy storage power supply according to claim 1, wherein the casing has an external profile extending in a first direction, a second direction, and a third direction, wherein the first direction, the second direction, and the third direction are perpendicular to each other, wherein:
the mounting wall is perpendicular to the third direction;
a lengthwise direction of the plurality of battery cells is arranged in the first direction or the second direction;
the inverter and the battery module are spaced apart in the first direction and electrically connected;
the substrate is disposed perpendicularly to the third direction;
the circuit component is disposed to extend in the third direction; and
a projection of the inverter in the first direction at least partially overlaps with a projection of the battery module in the first direction.

3. The energy storage power supply according to claim 2, wherein the battery module comprises a first battery module and a second battery module that are spaced apart from one another in the second direction, wherein:
the first battery module comprises a plurality of first battery cells arranged side by side in the first direction, a lengthwise direction of each of the plurality of first battery cells being arranged in the second direction, wherein each of the plurality of first battery cells, along a lengthwise direction thereof, has a first end and a second end; and
the second battery module comprises a plurality of second battery cells arranged side by side in the first direction, a lengthwise direction of each of the plurality of second battery cells being arranged in the second direction, wherein each of the plurality of second battery cells, along a lengthwise direction thereof, has a third end and a fourth end, the first end and the third end being opposite to each other.

4. The energy storage power supply according to claim 3, wherein:
each of the first end and the third end has a positive electrode and a negative electrode;
the first battery module further comprises a plurality of first busbars, the positive electrode of the first battery cell being connected to the negative electrode of an adjacent first battery cell through a corresponding first busbar of the plurality of first busbars;
the second battery module further comprises a plurality of second busbars, the positive electrode of the second battery cell is connected to the negative electrode of an adjacent second battery cell through a corresponding second busbar of the plurality of second busbars; and
the energy storage power supply further comprises a third busbar, wherein the first battery module and the second battery module are electrically connected to each other by connecting the plurality of first busbars to the plurality of second busbars through the third busbar.

5. The energy storage power supply according to claim 3, further comprising an isolation component disposed between the first end and the third end.

6. The energy storage power supply according to claim 5, wherein each of the first end and the third end is provided with a pressure relief valve, the isolation component being a heat insulation component.

7. The energy storage power supply according to claim 2, wherein the casing has a first mounting cavity and a second mounting cavity that are isolated from each other, wherein the battery module is mounted in the first mounting cavity, and wherein the inverter is mounted in the second mounting cavity.

8. The energy storage power supply according to claim 2, wherein the casing comprises a first mounting surface and a third mounting surface that are parallel to the third direction, wherein the first mounting surface is provided with at least one of an AC output socket and an AC input port, and wherein the third mounting surface is provided with a display screen.

9. The energy storage power supply according to claim 2, wherein a heat dissipation channel is formed in the casing, wherein the inverter is at least partially thermally coupled to the heat dissipation channel, and wherein a flow direction of the heat dissipation channel is parallel to the second direction.

10. The energy storage power supply according to claim 1, wherein:
the casing has a ventilation region, wherein the ventilation region has a plurality of heat dissipation holes, an inner cavity of the casing being in communication with an outside through the plurality of heat dissipation holes; and
the energy storage power supply further comprises a protection component, wherein the protection component comprises a protection mesh detachably connected to the casing and covering the ventilation region, a flow cross-sectional area of mesh openings of the protection mesh being smaller than a flow cross-sectional area of the plurality of heat dissipation holes.

11. The energy storage power supply according to claim 10, wherein:
a mounting groove corresponding to the ventilation region is formed on an outer side surface of the casing, wherein the protection component is at least partially received in the mounting groove; and
the protection component further comprises a mounting member, the mounting member being at least partially received in the mounting groove and being located at an outer side of the protection mesh.

12. The energy storage power supply according to claim 11, wherein:
the ventilation region comprises a first mounting region and a first grille, wherein the first grille is connected to a periphery of the first mounting region, and wherein the plurality of heat dissipation holes is formed on the first grille;
the mounting member comprises a second grille and a second mounting region, wherein the second grille is connected to a periphery of the second mounting region and directly faces towards the first grille; and
the protection component further comprises a first fastener, wherein the mounting member and the protection mesh are fixed to the casing by the first fastener sequentially passing through the second mounting region and the protection mesh and being connected to the first mounting region.

13. The energy storage power supply according to claim 1, wherein:
the casing has a ventilation region, the ventilation region comprising a first grille and a first mounting region, wherein the first grille is connected to a periphery of the first mounting region and has a plurality of heat dissipation holes, and wherein the first mounting region is configured to enhance a structural strength of the first grille; and
the energy storage power supply further comprises a cooling fan disposed in the casing and close to the plurality of heat dissipation holes, wherein the cooling fan is configured to generate an airflow passing through the plurality of heat dissipation holes, and wherein the cooling fan comprises a driving member and a blade coupled to the driving member, an orthographic projection of the driving member on the ventilation region at least partially overlapping with the first mounting region, and an orthographic projection of the blade on the ventilation region at least partially overlapping with the first grille.

14. The energy storage power supply according to claim 1, wherein the casing has a plurality of contoured grooves, and wherein the battery module further comprises a fixing member and a limiting member, wherein:
the fixing member has a plurality of fixing slots, an end of each of the plurality of battery cells in a lengthwise direction of the battery cell is fixed in a corresponding fixing slot of the plurality of fixing slots;
the battery cell has a side surface engaged with a corresponding contoured groove of the plurality of contoured grooves to be laid flat on the casing;
the fixing member is detachably connected to the casing;
the limiting member is connected to the casing; and
the limiting member comprises a limiting portion, the limiting portion having a plurality of limiting slots, wherein the side surface of the battery cell is further engaged with a corresponding limiting slot of the plurality of limiting slots, and wherein the limiting portion is connected to the casing to enable the other end of the battery cell in the lengthwise direction of the battery cell to be pressed between the plurality of limiting slots and the plurality of contoured grooves.

15. The energy storage power supply according to claim 1, wherein the casing has a mounting seat, the energy storage power supply comprises a second fastener, and the battery module comprises a first battery module and a second battery module, wherein the first battery module comprises a first fixing member provided with a plurality of first connection sheets, and wherein the second battery module comprises a second fixing member provided with a plurality of second connection sheets, wherein:
the plurality of first connection sheets and the plurality of second connection sheets are arranged and engaged in one-to-one correspondence and are stacked on the mounting seat; and
the second fastener is configured to pass through the plurality of first connection sheets and the plurality of second connection sheets and is fixed to the mounting seat.

16. The energy storage power supply according to claim 1, wherein the casing has an external profile extending in a first direction, a second direction, and a third direction, wherein the first direction, the second direction, and the third direction are perpendicular to each other, wherein:
a ratio of a dimension of the casing in the first direction to a dimension of the casing in the third direction is greater than 8;
the casing comprises a connection end surface perpendicular to the first direction;
the energy storage power supply further comprises a support bar detachably connected to the connection end surface;
a length direction of the support bar is parallel to the third direction;
the support bar comprises a first end and a second end that are arranged in the length direction of the support bar and are opposite to each other; and
a projection of the casing in the first direction, a projection of the first end of the support bar in the first direction, and a projection of the second end of the support bar in the first direction are arranged at intervals.

17. An energy storage power supply, wherein the energy storage power supply is in a cuboid shape, wherein:
a ratio of a length of the energy storage power supply to a thickness of the energy storage power supply is greater than 8;
a ratio of a width of the energy storage power supply to the thickness of the energy storage power supply is greater than 4; and
a capacity of the energy storage power supply is greater than 0.5 kWh.

18. An energy storage power supply system, comprising:
the energy storage power supply according to claim 1;
a power expansion pack; and
a cable configured to electrically connect the power expansion pack and the energy storage power supply.

19. The energy storage power supply system according to claim 18, wherein the energy storage power supply comprises a first contact surface and a first electrical connection port, and wherein the power expansion pack comprises a second contact surface and a second electrical connection port, wherein:
the energy storage power supply and the power expansion pack are configured with a first state and a second state, wherein:
in the first state of the energy storage power supply and the power expansion pack, the energy storage power supply or the power expansion pack is mounted on an external structure, and the first contact surface or the second contact surface directly faces the external structure; and
in the second state of the energy storage power supply and the power expansion pack, the first contact surface and the second contact surface face each other and are stacked; and
the cable comprises two power connection portions and a connection portion, wherein the two power connection portions are connected to the first electrical connection port and the second electrical connection port, respectively, wherein each of the two power connection portions comprises a lead end, and wherein two opposite ends of the connection portion pass through two lead ends of the two power connection portions and are electrically connected to the two power connection portions, respectively, the two lead ends directly facing each other in the first state of the energy storage power supply and the power expansion pack, and the two lead ends facing a same direction in the second state of the energy storage power supply and the power expansion pack.

20. The energy storage power supply system according to claim 18, wherein:
the energy storage power supply comprises a first contact surface provided with a plurality of first foot pads, and the power expansion pack comprises a second contact surface provided with a plurality of second foot pads, wherein when he energy storage power supply or the power expansion pack is mounted on an external structure, the first contact surface or the second contact surface directly faces the external structure, and the plurality of first foot pads and the plurality of second foot pads are in contact with the external structure; and
the energy storage power supply and the power expansion pack are configured with a first state and a second state, wherein:
in the first state of the energy storage power supply and the power expansion pack, the energy storage power supply or the power expansion pack is mounted on an external structure, the first contact surface or the second contact surface directly faces the external structure, and the plurality of first foot pads and the plurality of second foot pads are in contact with the external structure; and
in the second state of the energy storage power supply and the power expansion pack, the first contact surface and the second contact surface face each other and are stacked, and the plurality of first foot pads and the plurality of second foot pads are positioned and engaged with each other in one-to-one correspondence to enable the energy storage power supply and the power expansion pack to be stably stacked.
